(19) United States
(12) Patent Application Publication
(10) Pub. No.: US 2025/0226723 A1
(43) Pub. Date: Jul. 10, 2025

(54) ALTERNATOR COMPONENT

(71) Applicant: Generac Power Systems, Inc., Waukesha, WI (US)

(72) Inventors: Richard W. Lincoln, Mukwonago, WI (US); Jeff M. Vranak, Waukesha, WI (US); Casey J. Mickschl, Franklin, WI (US); Joel A. Wray, Janesville, WI (US)

(73) Assignee: Generac Power Systems, Inc., Waukesha, WI (US)

(21) Appl. No.: 19/013,660

(22) Filed: Jan. 8, 2025

Related U.S. Application Data
(60) Provisional application No. 63/618,760, filed on Jan. 8, 2024.

(51) Int. Cl. H02K 5/22; H02K 7/18

(52) U.S. Cl. CPC H02K 5/225; H02K 7/1815

(57) ABSTRACT

An example connector assembly for reconfiguring the voltage output of an alternator comprises a terminal block assembly and a cartridge connected thereto. The cartridge being configured to provide an electrical connection between a first lead and a second lead of an alternator connected to the terminal block assembly. The cartridge being selectively connected to the terminal block assembly and configured to cause the connector assembly to output a first voltage. A second cartridge being selectively connected to the terminal block assembly and configured to cause the connector assembly to output a second voltage.

### CROSS-REFERENCE TO RELATED APPLICATION(S)

This application claims priority to U.S. Provisional Application No. 63/618,760, filed on Jan. 8, 2024, the disclosure of which is hereby incorporated by reference in its entirety.

### BACKGROUND

Three-phase alternators are electrical devices used to generate alternating current (AC) power for various applications. These alternators include a rotor which rotates within a stator to produce electrical power. Three-phase alternators further include three separate windings, which are often evenly spaced around a stator of the alternator, each of the windings producing AC voltage. The windings are typically evenly spaced, forming a balanced system that helps ensure a continuous and smooth power output.

In operation, the alternator's rotor is driven by an external mechanical force, such as a turbine, engine, or crankshaft. As the rotor spins within the stator (stationary part), the changing magnetic field induces an electromotive force (EMF) in the windings. Due to the phasing arrangement of the windings, the voltage generated by each winding reaches its peak at a different point in time, creating a consistent and continuous supply of AC power. This arrangement enhances the overall efficiency and stability of the power generation process.

Three-phase alternators provide a constant power output, resulting in smoother performance for electrical systems compared to single-phase generators. Additionally, due to the balanced arrangement of windings, the mechanical stress on the generator is reduced, promoting longevity and reliability. Moreover, three-phase power transmission is more efficient over long distances, making these generators well suited for applications like power plants, industries, large commercial facilities, or electrical grids.

### SUMMARY

In general terms, this disclosure is directed to an alternator component. In some embodiments, and by non-limiting example, the alternator component comprises a connector assembly.

An aspect of the disclosure includes an alternator for a three-phase generator. The alternator comprises a rotor. The alternator further comprises a stator having a plurality of coils arranged thereon. Each of the coils includes two associated leads. The alternator further comprises a terminal block assembly to which the output leads are attached. The terminal block assembly includes a plurality of terminals. Each of the leads are connected to a terminal. The alternator further comprises a cartridge that is selectively connected to the terminal block assembly. The cartridge is electrically coupled to a plurality of the leads when the cartridge is connected to the terminal block assembly. The cartridge includes a conductive portion that extends between and electrically couples a first lead to a second lead of the plurality of leads.

Another aspect of the disclosure includes a connection assembly for reconfiguring the voltage output from an alternator. The connection assembly comprises a terminal block assembly comprising a plurality of terminals. The connection assembly further comprises a first cartridge that is selectively connected to the terminal block assembly. The terminal block is configured to receive a plurality of leads from the alternator within the plurality of terminals. The terminal block assembly is further configured to receive the first cartridge. The first cartridge provides an electrical connection between a first lead of the plurality of leads and a second lead of the plurality of leads when the first cartridge is received within the terminal block assembly.

### BRIEF DESCRIPTION OF THE DRAWINGS

FIG. 1 is a perspective view of an example generator.

FIG. 2 is a perspective view of an example alternator of the generator of FIG. 1.

FIG. 3 is a perspective view of an example connector assembly.

FIG. 4 is an exploded view of the connector assembly of FIG. 3.

FIG. 5 is a perspective view of an example mounting plate of the connector assembly of FIG. 3.

FIG. 6 is a top perspective view of an example base of the connector assembly of FIG. 3.

FIG. 7 is a bottom perspective view of the base of FIG. 6.

FIG. 8 is a detail perspective view of an example connection terminal and example junction terminal of the base of FIG. 6.

FIG. 9 is a bottom perspective view of an example cover of the connector assembly of FIG. 3.

FIG. 10 is a perspective view of an example voltage select cartridge of the connector assembly of FIG. 3.

FIG. 11 is a perspective view of another example voltage select cartridge of the connector assembly of FIG. 3.

FIG. 12 is a perspective view of the connector assembly of FIG. 3 with the cover removed.

FIG. 13 is a detail perspective view of an example connection terminal and junction terminal of the base of FIG. 6 with portions of the voltage select card of FIG. 10 arranged therein.

FIG. 14 is a cross sectional view of another example voltage select cartridge of the connector assembly of FIG. 3.

FIG. 15 is a cross sectional view of another example voltage select cartridge of the connector assembly of FIG. 3.

FIG. 16 is a cross sectional view of another example voltage select cartridge of the connector assembly of FIG. 3.

FIG. 17 is another perspective view of the connector assembly of FIG. 3.

FIG. 18 is a schematic view of the connector assembly of FIG. 3 with the voltage select cartridge of FIG. 14 arranged therein.

FIG. 19 is a circuit diagram of the stator leads and coils when the stator is connected to the connector assembly of FIG. 3 with the voltage select cartridge of FIG. 14 arranged therein.

FIG. 20 is a schematic view of the connector assembly of FIG. 3 with the voltage select cartridge of FIG. 15 arranged therein.

FIG. 21 is a circuit diagram of the stator leads and coils when the stator is connected to the connector assembly of FIG. 3 with the voltage select cartridge of FIG. 15 arranged therein.

FIG. 22 is a schematic view of the connector assembly of FIG. 3 with the voltage select cartridge of FIG. 16 arranged therein.

FIG. 23 is a circuit diagram of the stator leads and coils when the stator is connected to the connector assembly of FIG. 3 with the voltage select cartridge of FIG. 16 arranged therein.

FIG. 24 is a perspective view of another example voltage select cartridge of the connector assembly of FIG. 3.

FIG. 25 is a cross sectional view of the voltage select cartridge of FIG. 24.

FIG. 26 is another cross sectional view of the voltage select cartridge of FIG. 24.

FIG. 27 is a schematic view of the connector assembly of FIG. 3 with the voltage select cartridge of FIG. 24 arranged therein.

FIG. 28 is a circuit diagram of the stator leads and coils when the stator is connected to the connector assembly of FIG. 3 with the voltage select cartridge of FIG. 24 arranged therein.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The current disclosure is directed to multi-phase alternators. A three-phase twelve-lead alternator is a specific configuration of an alternator that has six stator coils and twelve output leads, with each coil having two associated output leads. In some examples, each of the coils is evenly spaced at 60-degree intervals around the stator. This type of alternator is designed to produce a three-phase AC output with twelve leads that can be connected to different load configurations. In some examples, this type of alternator is designed to produce a single phase AC output with twelve leads that can be connected to different load configurations. Each phase has two separate leads, often labeled with subscripts (e.g., A1, A2, B1, B2, C1, C2), indicating the different ends of the stator coils for each phase. The arrangement of the stator coils and the associated leads allows for flexibility in connecting the alternator to various electrical systems.

Similarly, a six lead three-phase alternator has three stator coils arranged around the stator core, each coil positioned 120 degrees apart from the others.

In some examples, alternators are built with dedicated voltages that are unable to be reconfigured. This can be problematic where different voltages are desired, as it requires the use of a different alternator. In other examples, alternators are built with the ability to be reconfigured to produce different output voltages. However, changing the voltage output of a three-phase alternator may be time consuming and error prone, and often times, must be performed by a highly trained technician. In some examples, changing the voltage of a three-phase alternator requires physically disconnecting and reordering alternator leads in a specific orientation. Such processes may also require the use of specialized equipment, such as terminal blocks and jumper blocks. In other examples, changing the voltage requires the use of a voltage selector switch, which is typically bulky and expensive. Other examples require the use of a voltage link board, which are also bulky and usually require trained technicians to operate. In some cases, errors in performing the above methods can lead to damaged equipment.

In some examples, the concepts provided in the current disclosure allow for a single alternator to be used and readily reconfigured to produce one or more different voltages. In some examples, the concepts provided in the current disclosure provide a low cost, reliable way to change the voltage output of an alternator without requiring a trained technician to do so.

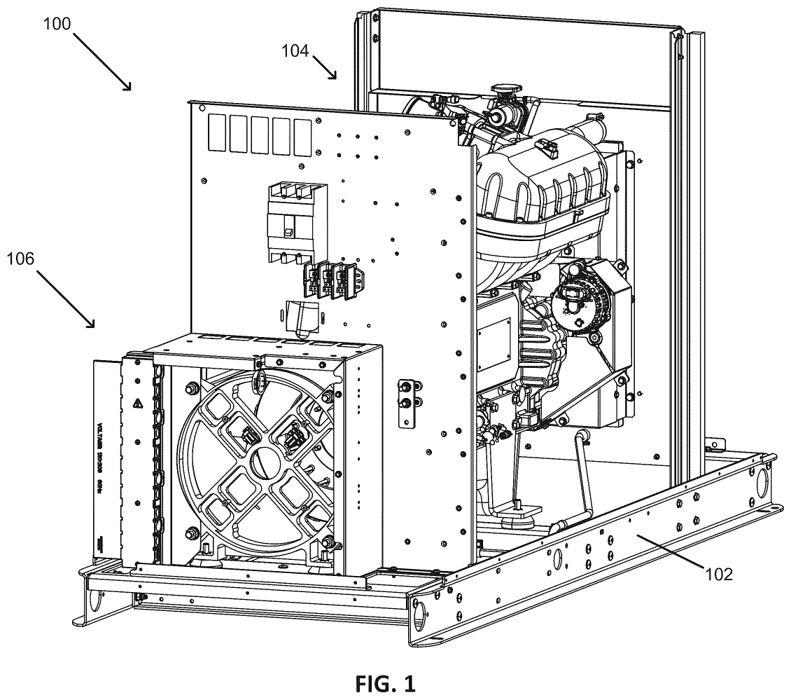

FIG. 1 is a perspective view of an example generator 100. In the example of FIG. 1, the generator 100 includes a housing (not shown), a frame 102, an engine 104, and an alternator 106. In some examples, when arranged within the generator 100, the engine 104 and the alternator 106 are placed on the frame 102 within the housing of the generator 100. In some examples, the engine 104 provides motive power, which drives the alternator 106. In some examples, the alternator 106 functions to provide alternating current electrical power. In some examples, the alternator 106 is a three-phase alternator.

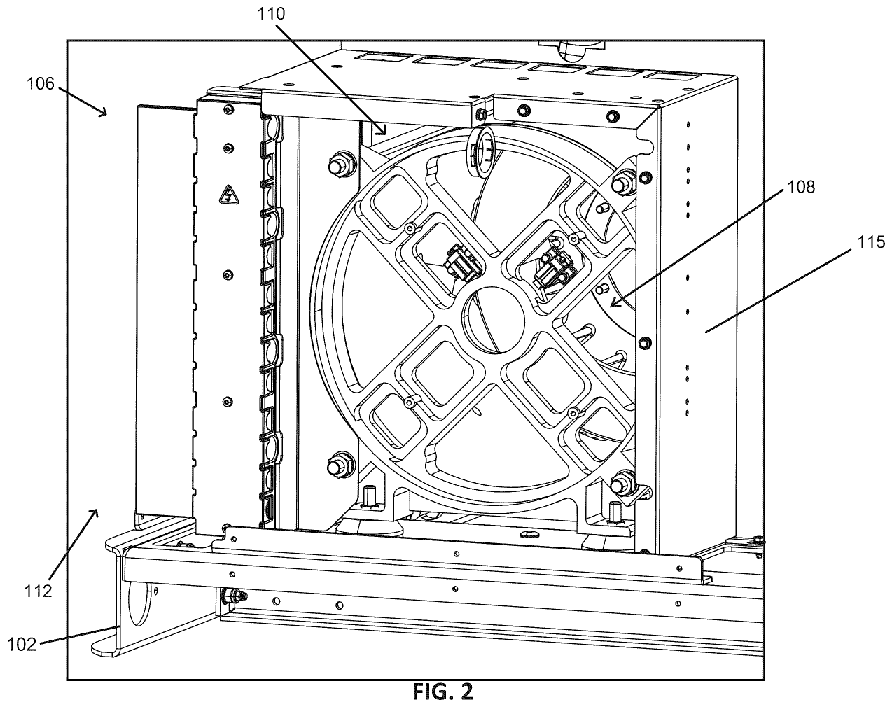

FIG. 2 is a perspective view of an example alternator 106 of the generator 100 of FIG. 1. In the example of FIG. 2, the alternator 106 includes a rotor 108, a stator 110, a connector assembly 112 and a frame 115.

In some examples, the rotor 108 is fixed within the alternator 106 but is able to rotate within the stator 110.

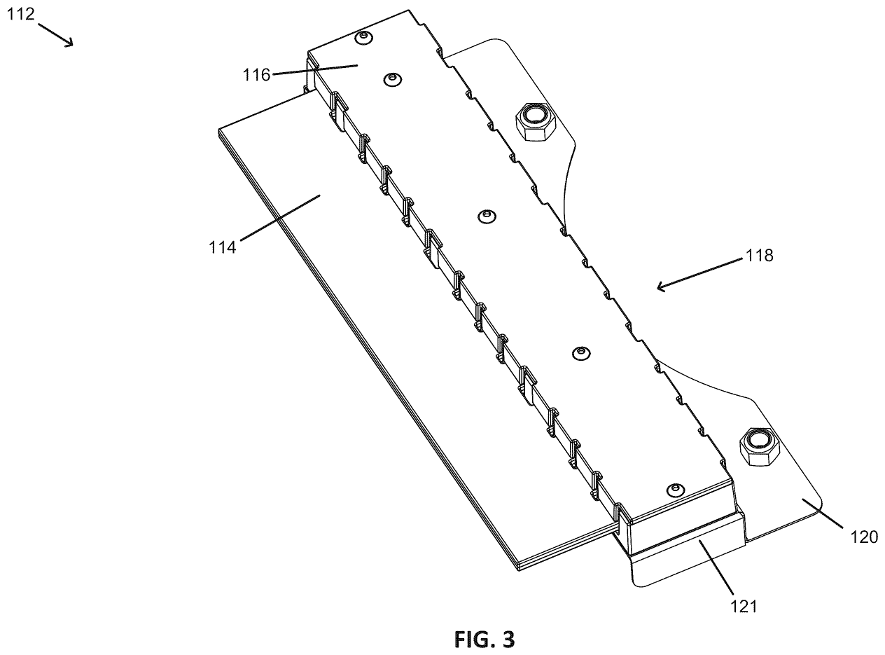

FIG. 3 is a perspective view of the connector assembly 112. In some examples, the connector assembly 112 includes a voltage select cartridge 114 and a terminal block assembly 118.

In some examples, the terminal block assembly 118 includes a cover 116, a base 121, and a mounting plate 120. In some examples, the cover 116 is arranged over the base 121 and forms a protective barrier over the base 121. In some examples, the mounting plate 120 is connected to the base 121 and functions to secure the connector assembly 112 to the frame 115 of the alternator 106.

In some examples, as shown in FIG. 3, the voltage select cartridge 114 is at least partially received by the terminal block assembly 118. Specifically, in some examples, one side of the voltage select cartridge 114 is received by the terminal block assembly 118. In some examples, another side of the voltage select cartridge 114 protrudes out from the terminal block assembly 118. In some examples, a portion of the voltage select cartridge 114 that protrudes out from the terminal block assembly 118 includes indicia thereon, such as, for example, indicia corresponding to a voltage output associated with the voltage select cartridge 114. In some examples, the voltage select cartridge 114 of the connector assembly 112 is interchangeable with other voltage select cartridges having different associated voltage outputs.

In some examples, the stator 110 includes a plurality of windings arranged thereon, each of which include two leads. In some examples, each lead of the windings of the stator 110 is electrically connected to the connector assembly 112. In some examples, as the rotor 108 rotates within the stator 110, an electrical voltage is produced by the windings and transmitted to the connector assembly 112.

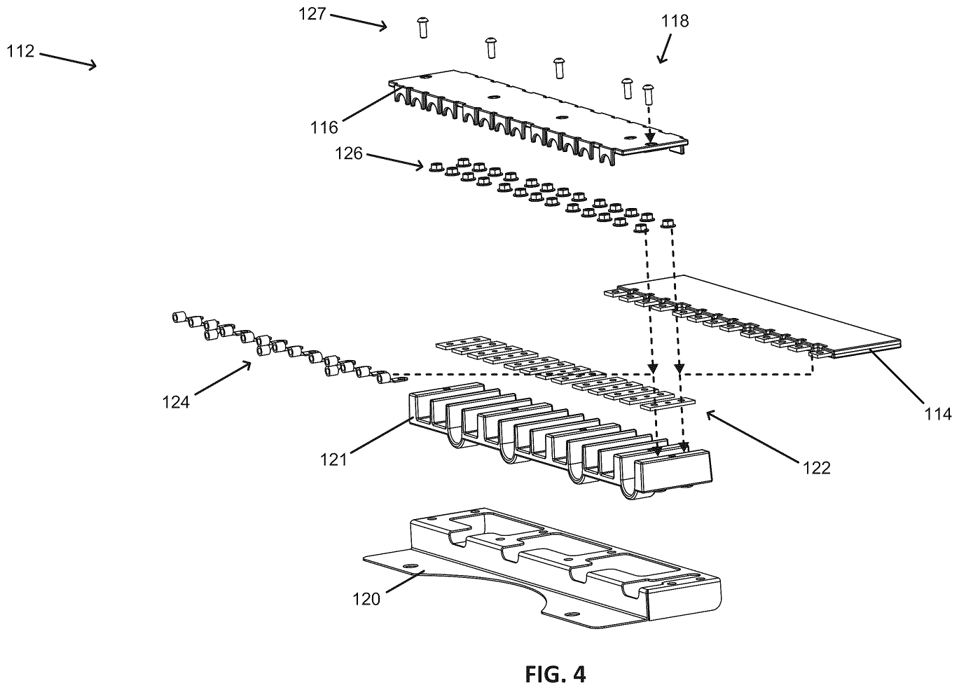

FIG. 4 is an exploded perspective view of the connector assembly 112. In some examples, the connector assembly includes the terminal block assembly 118, the voltage select cartridge 114, and further includes one or more lead connectors 124. In some examples, as noted above, the terminal block assembly 118 includes the cover 116, the mounting plate 120, and the base 121. In some examples, the terminal block assembly 118 further includes one or more connection bars 122, one or more connection fasteners 126, and one or more cover securing fasteners 127. In some examples, each of the mounting plate 120, the connection bars 122, the lead connectors 124, and the voltage select cartridge 114 are connected to the base 121 of the connector assembly 112.

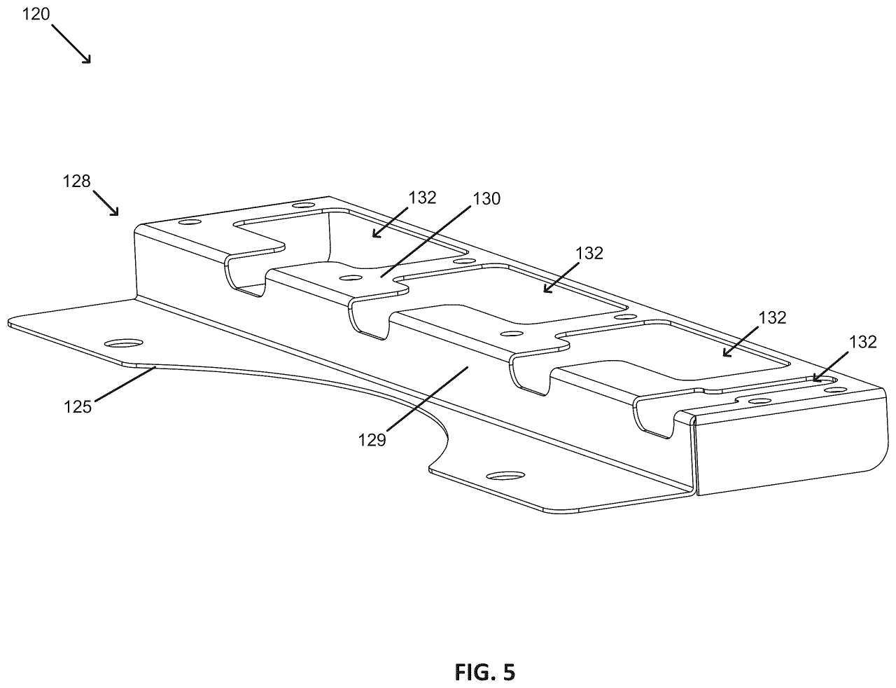

FIG. 5 is a perspective view of the mounting plate 120. In some examples, the mounting plate includes a mounting flange 125, and a mounting platform 128. The mounting flange 125 is connected to and extends out from the mounting platform 128 at a bottom side thereof. In some examples, the mounting flange 125 includes one or more holes through which fasteners may be extended through to secure the mounting flange 125 to an alternator.

The mounting platform 128 includes a side surface 129 and a top surface 130. that extends upwardly from the mounting flange 125, at which point it connects to the top surface 130. In some examples, the top surface 130 provides a space for the base 121 of the terminal block assembly 118 to be attached. In some examples, the top surface 130 includes a plurality of holes through which fasteners can be extended to attach to the terminal block assembly 118. In some examples, the top surface 130 and the side surface 129 include one or more cutouts 132 through which features on the base 121 of the terminal block assembly 118 extend when the base 121 is mounted to the top surface 130 of the mounting platform 128.

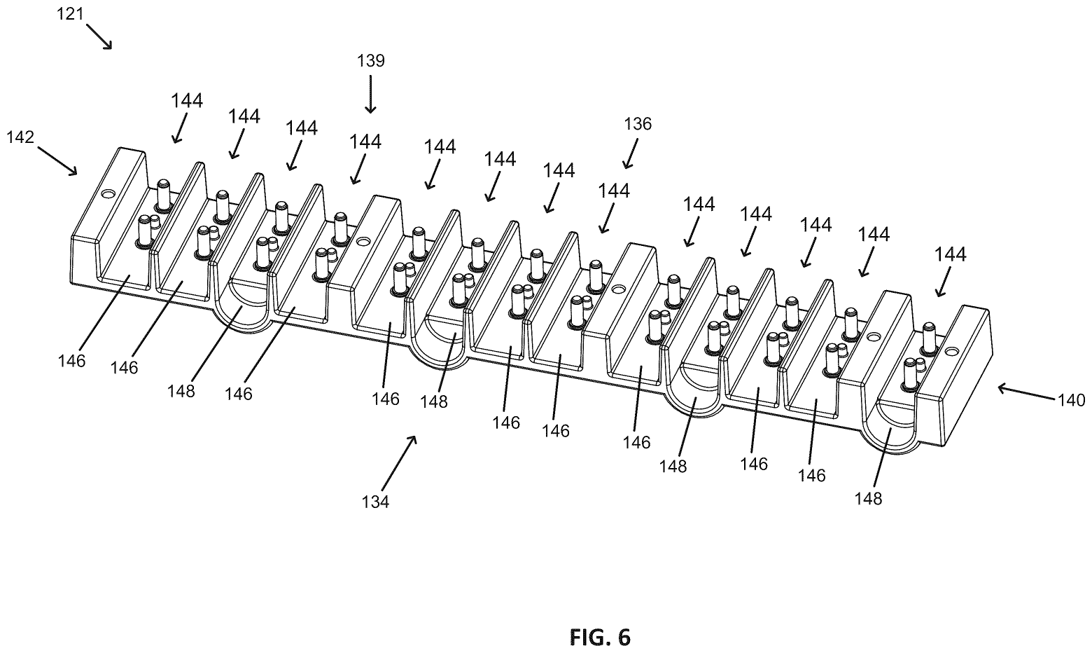

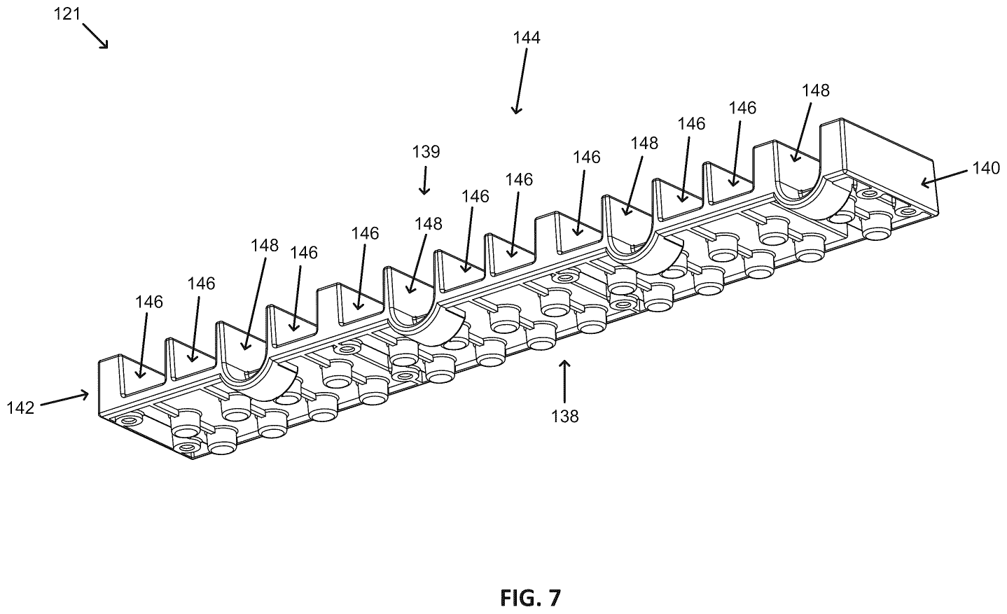

FIG. 6 and FIG. 7 depict the base 121 of the connector assembly 112. FIG. 6 is a perspective top view of the base 121 and FIG. 7 is a perspective bottom view of the connector assembly 112. In some examples, the base 121 includes a front side 134, a rear side 136, a bottom side 138, a top side 139, a left side 140, a right side 142, and a plurality of terminals 144. In some examples, the plurality of terminals 144 are formed in the top side 139 of the base 121 and are arranged along the length of the base 121. In some examples, each of the terminals 144 extends from the front side 134 to the rear side 136 of the base 121. In some examples, each of the terminals 144 are open from the front side 134, the rear side 136, and the top side 139 of the base 121.

In some examples, each of the terminals 144 are formed as channels in the base 121. In some examples, the plurality of terminals 144 includes one or more connection terminals 146 and one or more junction terminals 148. In some examples, the base includes four junction terminals 148 and nine connection terminals 146.

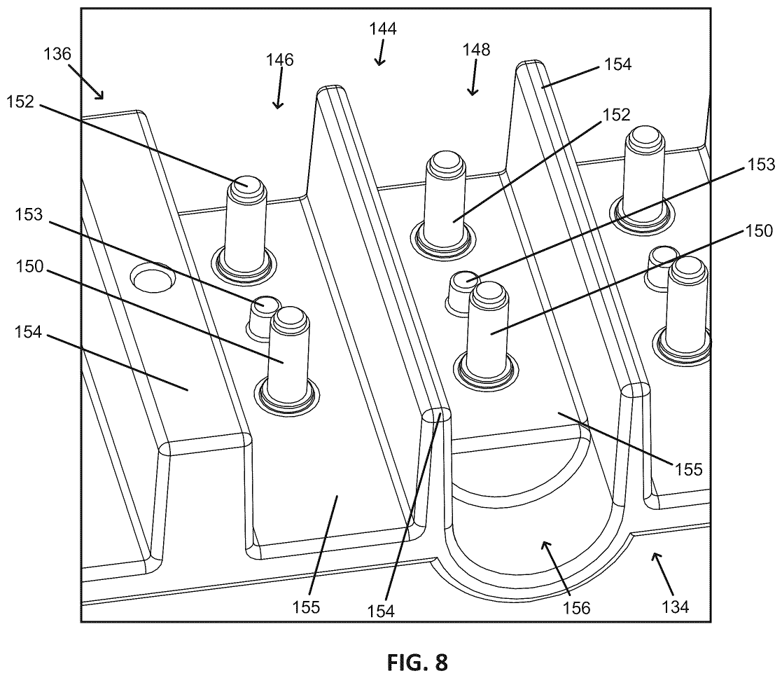

FIG. 8 is a detail perspective view of a connection terminal 146 and a junction terminal 148 of the base 121. In some examples, as shown in FIG. 8, each of the connection terminals 146 and the junction terminals 148 include a lead connection post 150, a cartridge connection post 152, and an alignment post 153 extending from the top side of each of the terminals 144. In some examples, each of the lead connection post 150, cartridge connection post 152, and alignment post 153 are formed in alignment within each of the terminals 144 between the front side 134 and the rear side 136 of the connector assembly 112. In some examples, one or more of the lead connection post 150, cartridge connection post 152, and alignment post 153 are formed as separate components from the base 121.

In some examples, each of the terminals 144 are separated from each other by a terminal wall 154. In some examples, the terminal walls 154 protrude upwardly from the top side 139 of the connector assembly 112 and extend between the front side 134 and the rear side 136 of the connector assembly 112. In some examples, one or more of the terminal walls 154 include a hole in a top side thereof in which a fastener extends to connect the cover 116 to the base 121.

In some examples, each of the terminals 144 include a bottom surface 155 from which the lead connection post 150, cartridge connection post 152, and alignment post 153 extend. In some examples, the bottom surface 155 of the connection terminals 146 extends from the front side to the rear side of the base 121. In some examples, the bottom surface 155 of the junction terminals 148 extends from the rear side of the base 121 to a point before the front side of the base 121.

In some examples, the terminal walls 154 extend upward from the from the bottom surface 155 of the terminals 144 and terminate at a point above one or more points at which the lead connection post 150, cartridge connection post 152, and alignment post 153 terminate.

In some examples, each of the junction terminals 148 further includes a recess 156 adjacent the front side 134 of the base. In some examples, the recess 156 extends below the bottom surface 155 of the junction terminals 148 and is open from the front side 134 of the base. In some examples, the recess 156 extends from the front side 134 of the base 121 to a point between the front side 134 of the base 121 and the lead connection post 150 of the junction terminal 148.

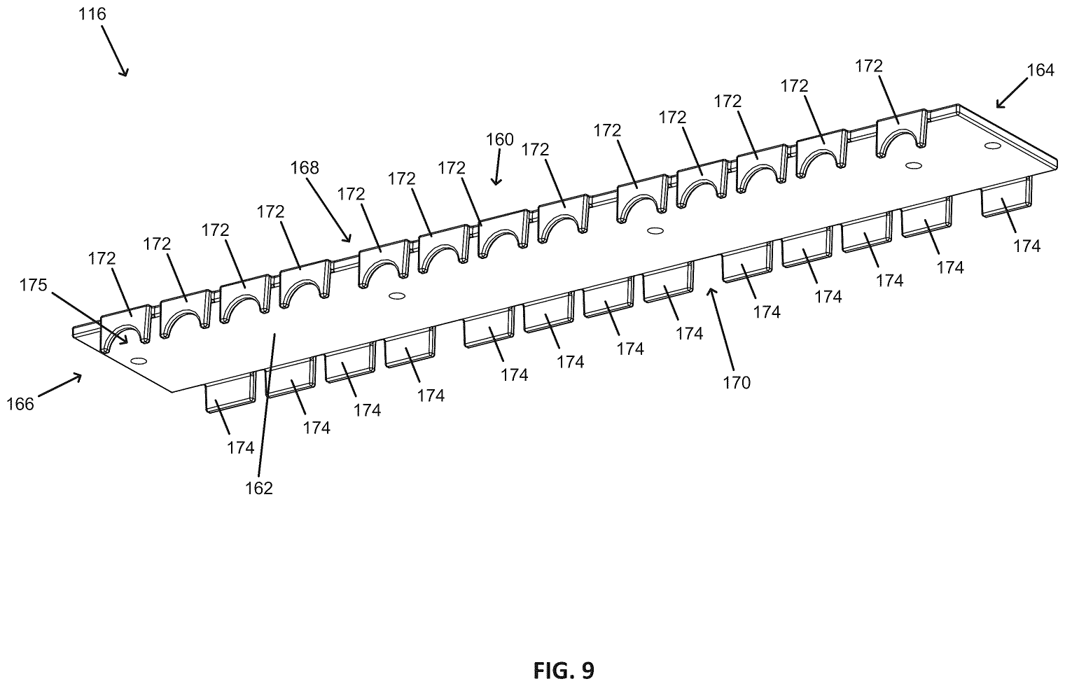

FIG. 9 is a bottom perspective view of the cover 116. In some examples, the cover 116 includes a top surface 160, a bottom surface 162, a left side 164, a right side 166, a front side 168, and a rear side 170. In some examples, the cover further includes a plurality of lead connection covers 172 and a plurality of cartridge connection covers 174.

In some examples, each of the top surface 160 and the bottom surface 162 of the cover 116 are substantially planar. In some examples, the cover 116 includes one or more holes extending through the top surface 160 and the bottom surface 162 through which fasteners may extend to connect the cover 116 to the base 121.

In some examples, the lead connection covers 172 extend down from a front edge of the bottom surface 162 in a direction substantially perpendicular from the bottom surface 162. In some examples, the lead connection covers are arranged along cover 116 between the left side 164 and the right side 166 of the covers. In some examples, the lead connection covers 172 are spaced according to the spacing of the terminals 144 of the base 121. In some examples, each of the lead connection covers 172 include a semicircular cutout 175 at a bottom edge thereof.

In some examples, each of the lead connection covers 172 includes a gap therebetween to accommodate the terminal walls 154 of the base 121 when the cover 116 is secured over the base 121.

In some examples, the cartridge connection covers 174 extend down from a rear edge of the bottom surface 162 in a direction substantially perpendicular from the bottom surface 162. In some examples, the cartridge connection covers 174 are arranged along cover 116 between the left side 164 and the right side 166 of the cover 116. In some examples, the cartridge connection covers 174 are spaced according to the spacing of the terminals 144 of the base 121.

In some examples, each of the cartridge connection covers 174 includes a gap therebetween to accommodate the terminal walls 154 of the base 121 when the cover 116 is secured over the base 121.

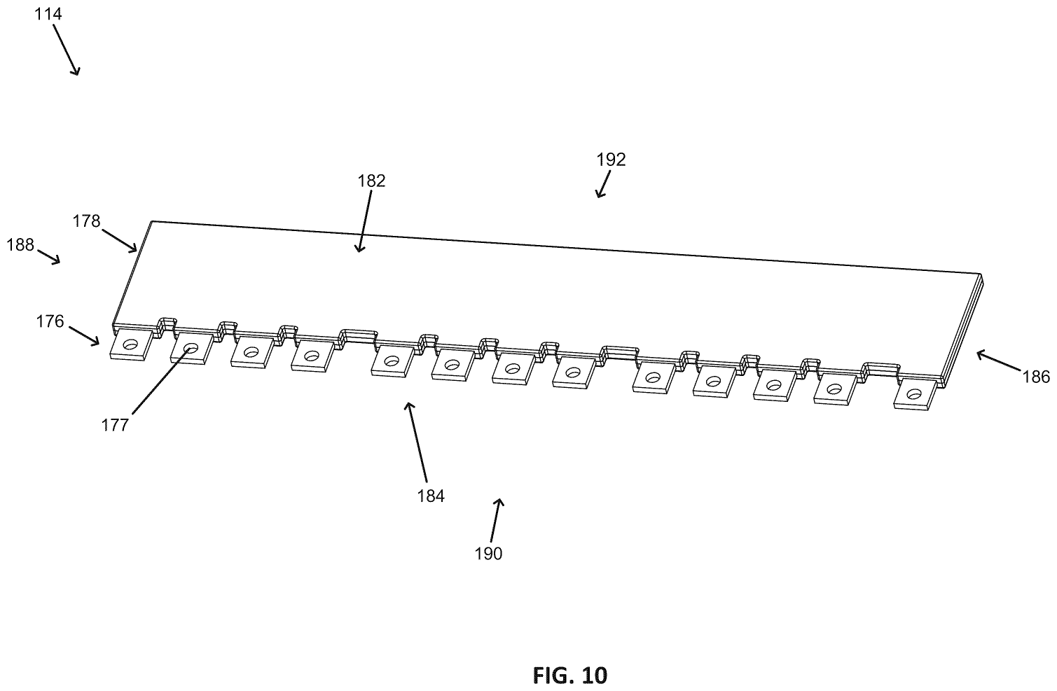

FIG. 10 is an example voltage select cartridge 114. The voltage select cartridge 114 includes a top side 182, a bottom side 184, a left side 186, a right side 188, a front side 190, and a rear side 192. In some examples, the voltage select cartridge 114 further includes a plurality of tabs 176 and a bus bar system 178. In some examples, the voltage select cartridge 114 is generally planar in shape.

In some examples, one or more of the tabs 176 of the plurality of tabs 176 are conductive. In some examples, the tabs 176 extend out from the bus bar system 178 at the front side 190 of the voltage select cartridge. In some examples, each of the plurality of tabs 176 includes a hole 177 arranged therethrough. In some examples, the plurality of tabs are arranged along a longitudinal front edge of the bus bar system 178 and extend out from the longitudinal front edge. In some examples, such as the example of FIG. 10, the voltage select cartridge 114 includes thirteen tabs 176. In other embodiments, the voltage select cartridge 114 includes different numbers of tabs 176. In some examples, the tabs 176 are arranged between the left side 186 and the right side 188 of the voltage select cartridge 114.

In some examples, the bus bar system 178 includes an insulating layer positioned on top of the bus bar system 178. In some examples, the bus bar system 178 includes a second insulating layer positioned on the bottom of the bus bar system 178. In some examples, the bus bar system 178 includes one or more conductive traces arranged between the top insulating layer and the bottom insulating layer. In some examples, the one or more conductive traces electrically connect one or more of the plurality of tabs 176 of the voltage select cartridge 114 to another of the plurality of tabs 176 of the voltage select cartridge 114.

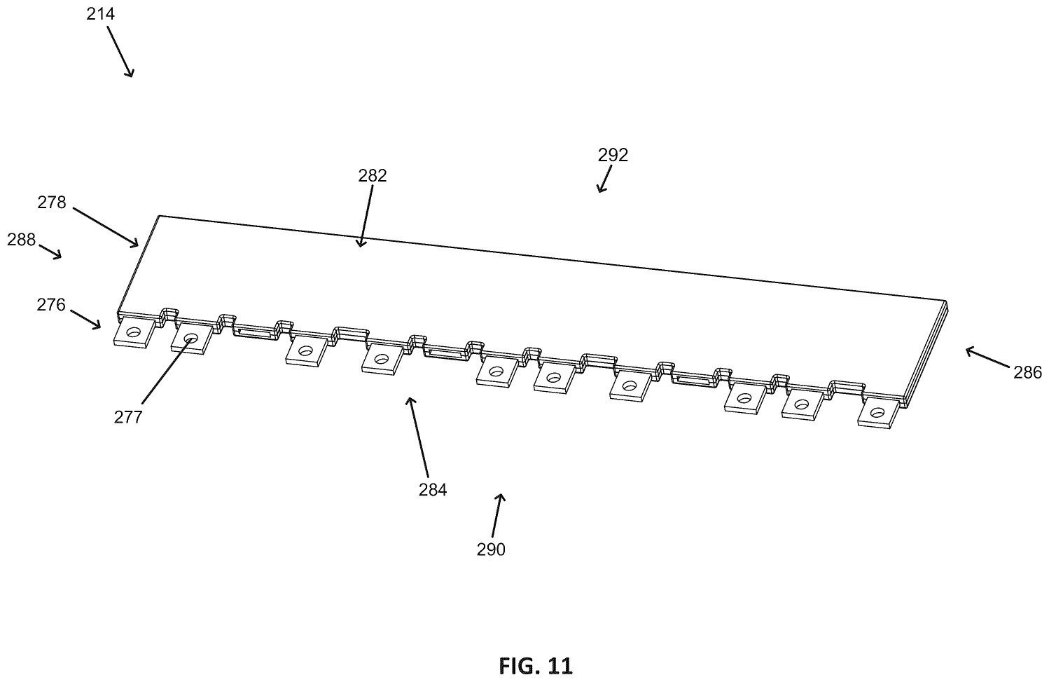

FIG. 11 is a perspective view of another example voltage select cartridge 214. In some examples, the voltage select cartridge 214 is configured substantially similarly to the voltage select cartridge 114 of FIG. 10. In some examples, the voltage select cartridge 214 is interchangeable with the voltage select cartridge 114 of FIG. 10 within the connector assembly 112. In some examples, like the voltage select cartridge 114 of FIG. 10, the voltage select cartridge 214 includes a top side 282, a bottom side 284, a left side 286, a right side 288, a front side 290, and a rear side 292. In some examples, the voltage select cartridge 214 further includes a plurality of tabs 276 and a bus bar system 278. In some examples, the tabs 276 include holes 277. In some examples, the voltage select cartridge 214 differs from the voltage select cartridge 114 of FIG. 10 in that the voltage select cartridge 214 includes 10 tabs 276 as opposed to the thirteen tabs 176 of the voltage select cartridge 114 of FIG. 10.

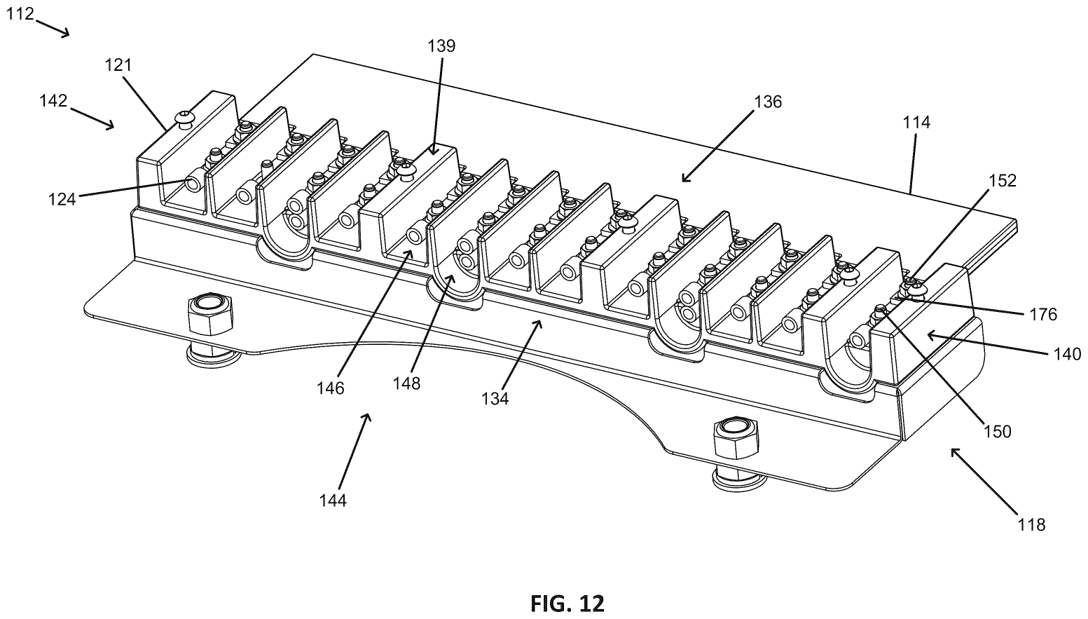

FIG. 12 is an example connector assembly 112 with the cover 116 removed. As shown in FIG. 12, the connector assembly 112 includes the terminal block assembly 118 with the voltage select cartridge 114 and the lead connectors 124 arranged therein.

As shown in FIG. 12, when assembled, the tabs 176 of the voltage select cartridge 114 extend into the terminals 144 from the rear side 136 of the base 121. In some examples, the cartridge connection posts 152 of the terminals 144 protrude through the holes 177 in the tabs 176 of the voltage select cartridge 114, thereby helping to secure and align the voltage select cartridge 114 within the terminal block assembly 118.

Likewise, as shown in FIG. 12, when assembled, the lead connectors 124 are also arranged within the terminals 144. In some examples, the lead connectors 124 are arranged within the terminals 144 at the front side 134 of the base 121. In some examples, a portion of the lead connectors 124 surrounds the lead connection posts 150 of the terminals 144.

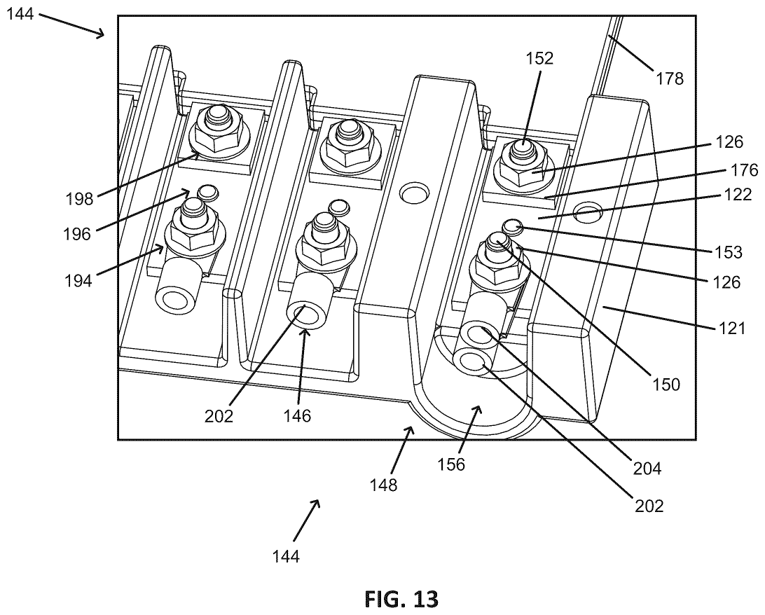

FIG. 13 is a detail perspective view of a connection terminal 146 and a junction terminal 148 of the base 121 with the lead connectors 124 and the tabs 176 of the voltage select cartridge 114 arranged therein.

In some examples, when the connector assembly 112 is assembled, a 122 connection bar is arranged within each of the connection terminals 146 and the junction terminals 148 of the base 121. In some examples, the connection bars 122 are formed as rectangular sheets. In some examples, the connection bars 122 are electrically conductive. In some examples, a portion of the connection bars 122, such as a bottom surface of the connection bars 122 is electrically insulating. In some examples, when arranged within the connection terminals 146 and the junction terminals 148, an insulating layer extends between the connection bars 122 and the surface of the connection terminals 146 as well as the connection bars 122 and the surface of the junction terminals 148. In some examples, each of the connection bars 122 includes a lead post hole 194, an alignment post hole 196, and a cartridge post hole 198. In some examples, when arranged in the terminals 144, the lead connection post 150 extends through the lead post hole 194, the alignment post 153 extends through the alignment post hole 196 and the cartridge connection post 152 extends through the cartridge post hole 198. In some examples, the connection bars 122 are substantially planar. In some examples, when arranged within the connection terminals 146 and the junction terminals 148, the connection bars 122 lie flat along the bottom surface 155 of the connection terminals 146 and the junction terminals 148.

In some examples, in each of the connection terminals 146 and the junction terminals 148, when the cartridge connection posts 152 are extended through the holes in the tabs 176 of the voltage select cartridge 114, connection fasteners 126 are threaded onto the cartridge connection posts 152 over the tabs 176 such that the tabs 176 are secured in place between the connection fasteners 126 and the bottom surface 155 of the terminals 144. In some examples, when secured in place against the connection bars 122 the tabs 176 form an electrical connection with the connection bars 122. In some examples, when the tabs 176 are inserted into the terminals 144 of the base 121, the bus bar system 178 of the voltage select cartridge 114 extends out from the rear side of the base 121 and is substantially parallel with the bottom surface 155 of the terminals 144.

In some examples, the lead connectors 124 are formed as ring terminals. In some examples, the lead connectors 124 include a plurality of input connectors 202 and a plurality of output connectors 204. In some examples, each of the connection terminals 146 includes an input connector 202. In some examples, fewer than all of the connection terminals 146 includes an input connector 202. In some examples, each of the connection terminals 146 includes only one input connector 202. In some examples, when arranged within the connection terminals 146, the lead connection post 150 extends through a hole in the input connectors 202. In some examples, the connection fastener 126 is threaded onto the lead connection post 150. In some examples, the input connector 202 is secured within the connection terminals 146 between the connection bar 122 and the connection fastener 126. In some examples, when secured within the connection terminal 146, the input connector 202 forms an electrical connection with the connection bar 122 and respective tab 176 of the respective connection terminal 146.

In some examples, each of the junction terminals 148 also include an input connector 202. In some examples, fewer than each of the junction terminals 148 includes in input connector 202. In some examples, three of the four junction terminals 148 include an input connector 202. In some examples, the input connectors 202 are electrically connected to leads of the stator 110. In some examples, the input connectors 202 provide an electrical connection between the leads of the stator 110 and other components of the connector assembly 112.

In some examples, the output connectors 204 are connected to output leads, which deliver electrical power to other components of an electrical distribution system, such as, for example, a circuit breaker. In some examples, each of the junction terminals 148 includes an output connector 204. In some examples, one or more of the junction terminals 148 may include both an input connector 202 and an output connector 204. In such examples, the input connector 202 and the output connector 204 are stacked on top of one another within the junction terminals 148. For example, in some examples, the input connector 202 is arranged on top of a connection bar 122 of a junction terminal 148 with the associated lead connection post 150 extending through the hole of the input connector 202. The output connector 204 is arranged over the input connector 202 with the with the associated lead connection post 150 also extending through the hole of the output connector 204. The connection fastener 126 is threaded onto the associated lead connection post 150 over the output connector 204. Thus, the output connector 204 is secured between the connection fastener 126 and the input connector 202 is secured between the output connector 204 and the connection bar 122. In other examples, the placement of the input connector 202 and the output connector 204 is reversed such that the input connector 202 is arranged over the output connector 204. In some examples, when secured within the junction terminal 148, the input connector 202 and the output connector 204 are electrically connected to each other and are also electrically connected to the connection bar 122 and the associated tab 176 of the associated junction terminal 148. In some examples, when arranged in the stacked configuration, a portion of one of the input connector 202 and the output connector 204 is located within the recess 156 of the base 121. In some examples, the connection bar 122 forms an electrical connection with the input connector 202, the output connector 204, and the associated tab 176.

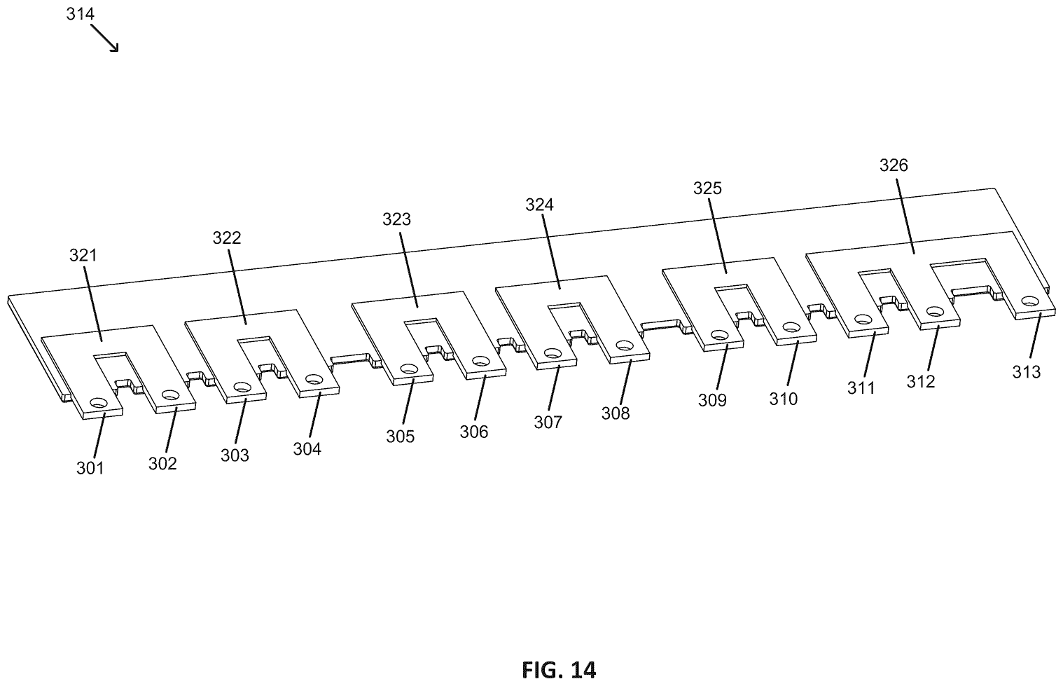

FIG. 14 is a cross sectional view of an example voltage select cartridge 314, such as the voltage select cartridge 114 of FIG. 10, depicting a first trace configuration. In some examples, the first trace configuration is configured to provide a phase to neutral output voltage of 120V and a phase to phase output voltage of 240V. In the example of FIG. 14, the voltage select cartridge 314 includes a first tab 301, a second tab 302, a third tab 303, a fourth tab 304, a fifth tab 305, a sixth tab 306, a seventh tab 307, an eighth tab 308, a ninth tab 309, a tenth tab 310, an eleventh tab 311, a twelfth tab 312, a thirteenth tab 313, a first trace 321, a second trace 322, a third trace 323, a fourth trace 324, a fifth trace 325, and a sixth trace 326. In the example of FIG. 14, the first tab 301 is conductively connected by the first trace 321 trace to the second tab 302. The third tab 303 is conductively connected by the second trace 322 trace to the fourth tab 304. The fifth tab 305 is conductively connected by the third trace 323 to the sixth tab 306. The seventh tab 307 is conductively connected by the fourth trace 324 to the eighth tab 308. The ninth tab 309 is conductively connected by the fifth trace 325 to the tenth tab 310. The eleventh tab 311 is conductively connected by the sixth trace 326 to the twelfth tab 312, both of which are also conductively connected the sixth trace 326 trace to the thirteenth tab 313.

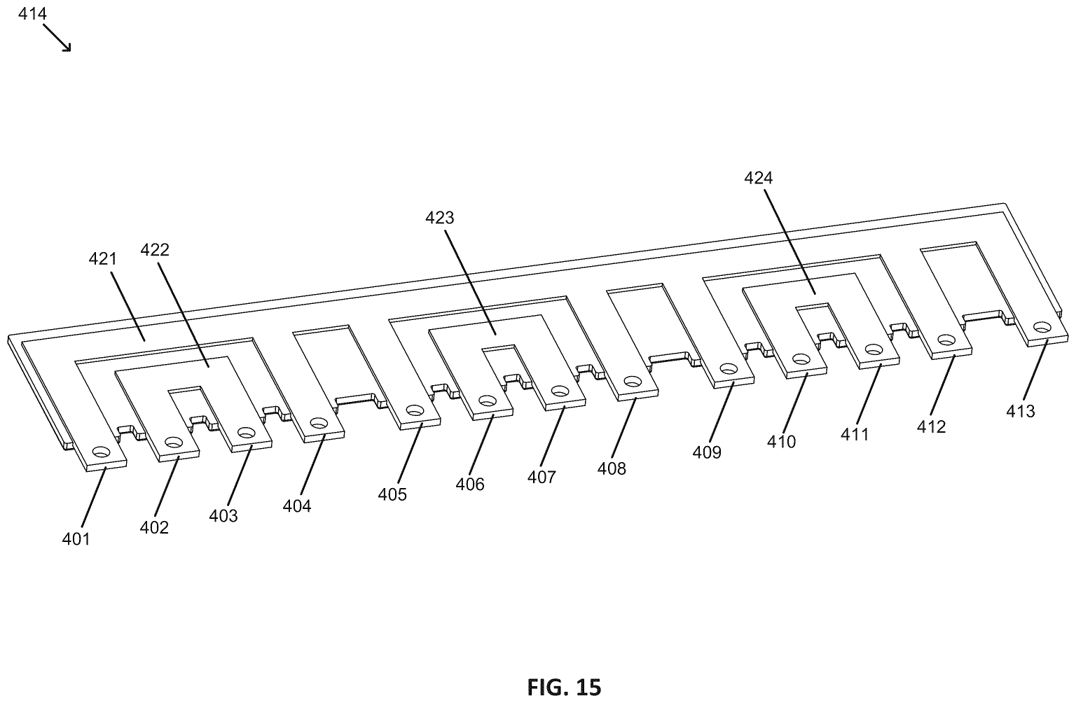

FIG. 15 is a cross sectional view of another example voltage select cartridge 414, such as the voltage select cartridge 114 of FIG. 10, depicting a second trace configuration. In some examples, the second trace configuration is configured to provide a phase to neutral output voltage of 120V and a phase to phase output voltage of 208V. In the example of FIG. 15, the voltage select cartridge 414 includes a first tab 401, a second tab 402, a third tab 403, a fourth tab 404, a fifth tab 405, a sixth tab 406, a seventh tab 407, an eighth tab 408, a ninth tab 409, a tenth tab 410, an eleventh tab 411, a twelfth tab 412, a thirteenth tab 413, a first trace 421, a second trace 422, a third trace 423, and a fourth trace 424. In the example of FIG. 15, the first tab 401 is conductively connected by the first trace 421 to the fourth tab 404, which are conductively connected by the first trace 421 trace to the fifth tab 405, which are conductively connected by the first trace 421 to the eighth tab 408, which are conductively connected by the first trace 421 trace to the ninth tab 409, which are conductively connected by the first trace 421 to the twelfth tab 412, which are conductively connected by the first trace 421 to the thirteenth tab 413. The second tab 402 is conductively connected by the second trace 422 to the third tab 403. The sixth tab 406 is conductively connected by the third trace 423 to the seventh tab 407. The tenth tab 410 is conductively connected by the fourth trace 424 to the eleventh tab 411.

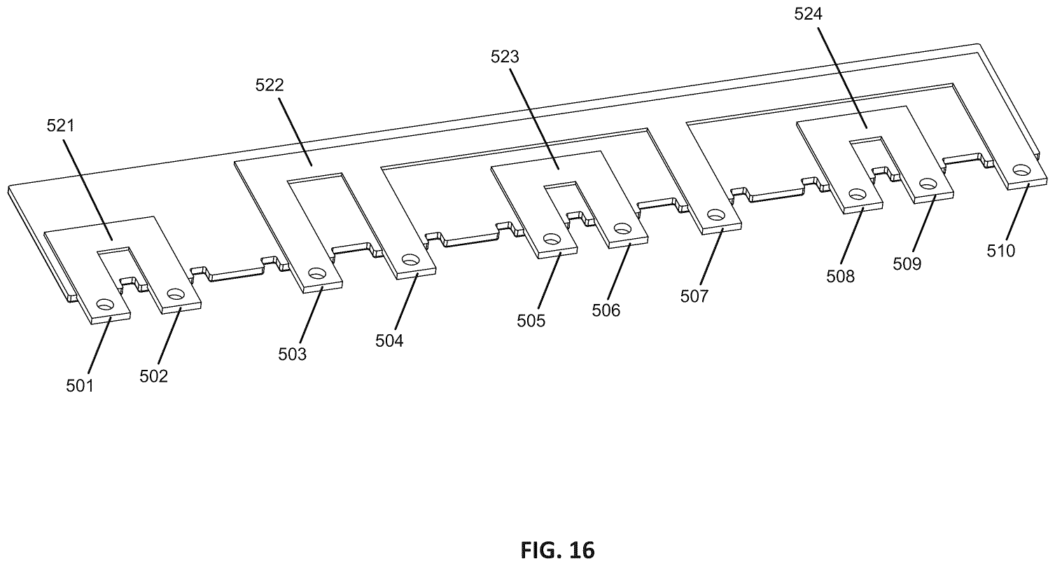

FIG. 16 is a cross sectional view of another example voltage select cartridge 514, such as the voltage select cartridge 214 of FIG. 11, depicting a third trace configuration. In some examples, the third trace configuration is configured to provide a phase to neutral output voltage of 277V and a phase to phase output voltage of 480V. In the example of FIG. 16, the voltage select cartridge 514 includes a first tab 501, a second tab 502, a third tab 503, a fourth tab 504, a fifth tab 505, a sixth tab 506, a seventh tab 507, an eighth tab 508, a ninth tab 509, a tenth tab 510, a first trace 521, a second trace 522, a third trace 523, and a fourth trace 524. In the example of FIG. 16, the first tab 501 is conductively connected by the first trace 521 to the second tab 502, the third tab 503 is conductively connected by the second trace 522 to the fourth tab 504, which are conductively connected by the second trace 522 to the seventh tab 507, which are conductively connected by the second trace 522 to the tenth tab 510. The fifth tab 505 is conductively connected by the third trace 523 to the sixth tab 506. The eighth tab 508 is conductively connected by the fourth trace 524 to the ninth tab 509.

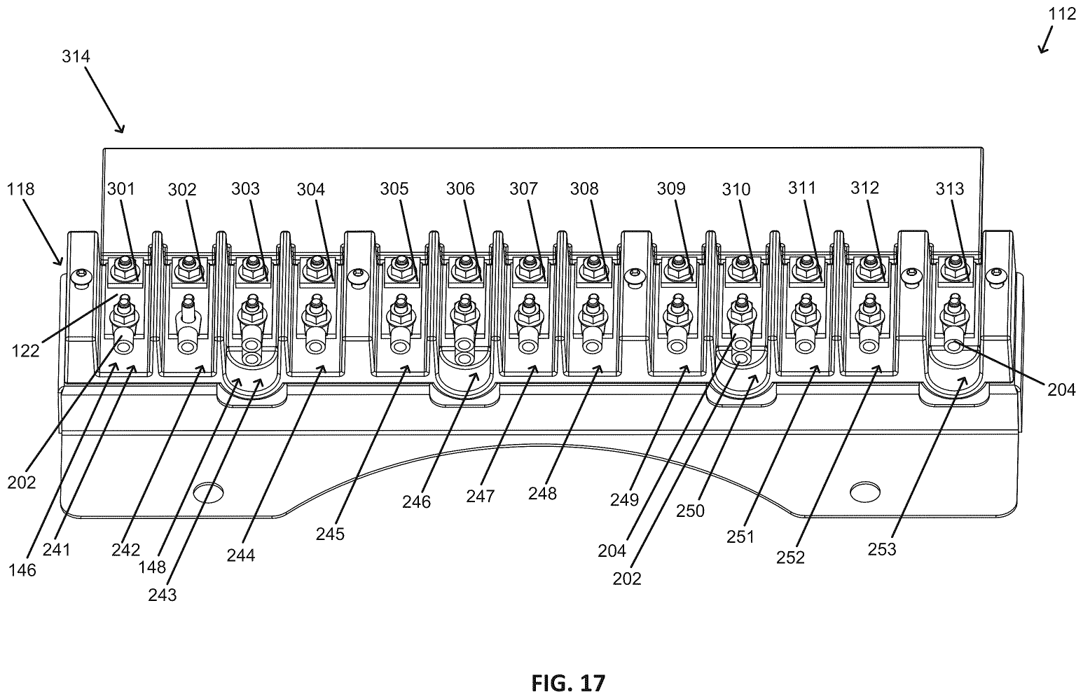

FIG. 17 is an example connector assembly 112 with the cover 116 removed. As shown in FIG. 17, the connector assembly 112 includes the terminal block assembly 118 with the voltage select cartridge 314 and the lead connectors 124 arranged therein.

In some examples, the terminal block assembly 118 includes a first terminal 241, a second terminal 242, a third terminal 243, a fourth terminal 244, a fifth terminal 245, a sixth terminal 246, a seventh terminal 247, an eight terminal 248, a ninth terminal 249, a tenth terminal 250, an eleventh terminal 251, a twelfth terminal 252, and a thirteenth terminal 253.

In some examples, all of the terminals 241, 242, 243, 244, 245, 246, 247, 248, 249, 250, 251, 252 includes an associated connection bar 122. In some examples, terminals 241, 242, 244, 245, 247, 248, 249, 251, 252 are formed as connection terminals include an associated input connector 202. In some examples terminals 243, 246, 250 are junction terminals 148 and include an associated input connector 202 and an associated output connector 204. In some examples, terminal 253 is formed as a junction terminal 148 and includes an associated output connector 204. In some examples, as shown in FIG. 17, each of the first tab 301, second tab 302, third tab 303, fourth tab 304, fifth tab 305, sixth tab 306, seventh tab 307, eighth tab 308, ninth tab 309, tenth tab 310, eleventh tab 311, twelfth tab 312, and thirteenth tab 313 is received within the first terminal 241, second terminal 242, third terminal 243, fourth terminal 244, fifth terminal 245, sixth terminal 246, seventh terminal 247, eighth terminal 248, ninth terminal 249, tenth terminal 250, eleventh terminal 251, twelfth terminal 252, and thirteenth terminal 253, respectively.

In some examples, when arranged within the alternator 106 of FIG. 2, terminals 241, 242, 243, 244, 245, 246, 247, 248, 249, 250, 251, 252 are electrically connected to the stator 110 of the alternator 106 by one or more leads. In some examples, the one or more leads comprise conductive wires. In some examples, the stator is connected to the terminals 241, 242, 243, 244, 245, 246, 247, 248, 249, 250, 251, 252 of the terminal block assembly 118 by a first lead, a second lead, a third lead, a fourth lead, a fifth lead, a sixth lead, a seventh lead, an eighth lead, a ninth lead, a tenth lead, an eleventh lead, and a twelfth lead. In some examples, each of the leads is connected to an input connector 202 arranged in one of the associated terminals 241, 242, 243, 244, 245, 246, 247, 248, 249, 250, 251, 252.

In some examples, the sixth lead is connected to the first terminal 241, the ninth lead is connected to the second terminal 242, the third lead is connected to the third terminal 243, the tenth lead is connected to the fourth terminal 244, the twelfth lead is connected to the fifth terminal 245, the second lead is connected to the sixth terminal 246, the eighth lead is connected to the seventh terminal 247, the fifth lead is connected to the eighth terminal 248, the eleventh lead is connected to the ninth terminal 249, the first lead is connected to the tenth terminal 250, the seventh lead is connected to the eleventh terminal 251, and the fourth lead is connected to the twelfth terminal 252.

In some examples, the output connectors 204 of the third terminal 243, sixth terminal 246, tenth terminal 250, and thirteenth terminal 253 are connected to a circuit breaker by a first output lead, a second output lead, a third output lead, and a neutral output lead. In some examples, the third output lead is connected to the third terminal 243, the second output lead is connected to the sixth terminal 246, the first output lead is connected to the tenth terminal 250, and the neutral output lead is connected to the neutral terminal.

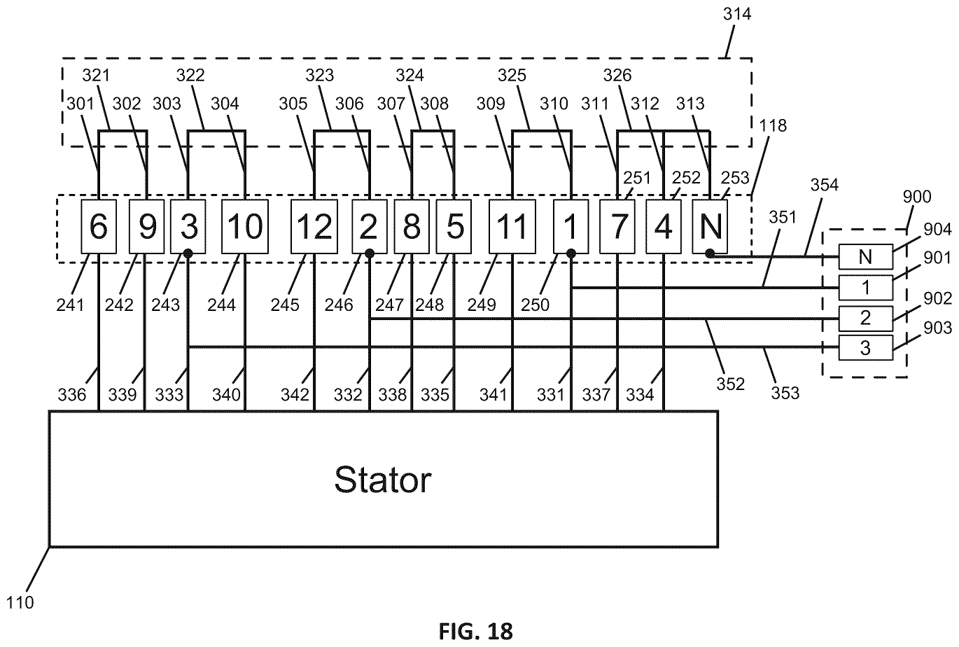

FIG. 18 is a schematic view of the connector assembly 112 of FIG. 17 with the voltage select cartridge 314 arranged therein. In the example of FIG. 18, the first lead 331, second lead 332, third lead 333, fourth lead 334, fifth lead 335, sixth lead 336, seventh lead 337, eighth lead 338, ninth lead 339, tenth lead 340, eleventh lead 341, and twelfth lead 342 are shown connected to the terminals 241, 242, 243, 244, 245, 246, 247, 248, 249, 250, 251, 252, as described above with reference to FIG. 17. Furthermore, first output lead 351, second output lead 352, third output lead 353, and neutral output lead 354 are shown connected at a first end to the third terminal 243, the sixth terminal 246, the tenth terminal 250, and the thirteenth terminal 253, as described with reference to FIG. 17. The first output lead 351, second output lead 352, third output lead 353, and neutral output lead 354 are further shown connected at a second end to the to the circuit breaker 900 at a circuit breaker first input 901, circuit breaker second input 902, circuit breaker third input 903, and circuit breaker neutral input 904, respectively. In some examples, when arranged in the configuration of FIG. 18, the connector assembly 112 is configured to output a phase to neutral voltage of 120V and a phase to phase voltage of 240V to the circuit breaker 900. In some examples, the circuit breaker 900 is configured to deliver power to various other electrical components or devices.

In some examples, as depicted in FIG. 18, when the stator leads 331, 332, 333, 334, 335, 336, 337, 338, 339, 340, 341, 342, are connected to the terminals 241, 242, 243, 244, 245, 246, 247, 248, 249, 250, 251, 252; the tabs 301, 302, 303, 304, 305, 306, 307, 308, 309, 310, 311, 312, 313 are connected to the terminals 241, 242, 243, 244, 245, 246, 247, 248, 249, 250, 251, 252, 253; and the circuit breaker inputs 901, 902, 903, 904 are connected to the terminals 243, 246, 250, 253, one or more of the above referenced components form an electrical connection. Specifically, the sixth lead 336, the first tab 301, the first trace 321, the second tab 302, and the ninth lead 339 are electrically connected. The third lead 333, the third output lead 353, the third input 903, the third tab 303, the second trace 322, the fourth tab 304, and the tenth lead 340 are electrically connected. The twelfth lead 342, the fifth tab 305, the third trace 323, the sixth tab 306, the second output lead 352, the second input 902, and the second lead 332 are electrically connected. The eighth lead 338, the seventh tab 307, the fourth trace 324, the eighth tab 308, and the fifth lead 335 are electrically connected. The eleventh lead 341, the ninth tab 309, the fifth trace 325, the tenth tab 310, the first output lead 351, the first input 901, and the first lead 331 are electrically connected. The seventh lead 337, the eleventh tab 311, the sixth trace 326, the twelfth tab 312, the fourth lead 334, the thirteenth tab 313, the neutral output lead 354, and the neutral input 904 are electrically connected.

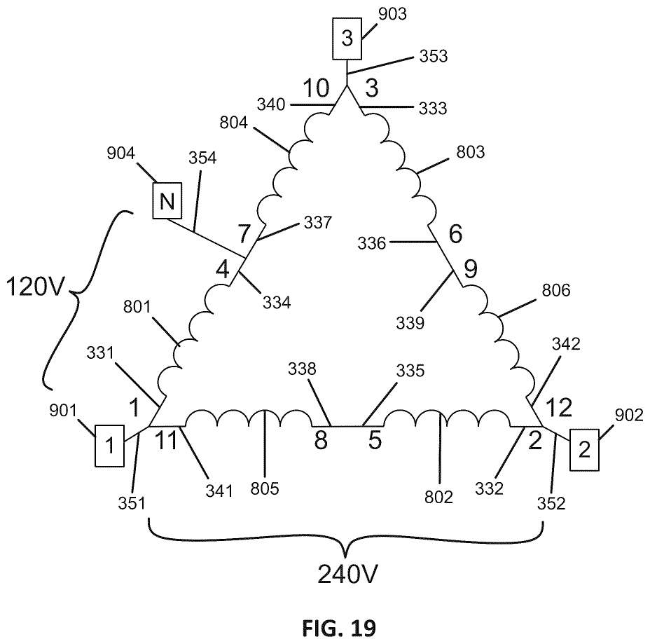

FIG. 19 is a circuit diagram of the stator leads and coils when connected to the connector assembly 112 and voltage select cartridge 314, depicted in FIG. 18. In the example of FIG. 19, a first coil 801, second coil 802, third coil 803, fourth coil 804, fifth coil 805, and sixth coil 806 of the stator 110 are shown. As shown in FIG. 19, when connected to the connector assembly 112 and voltage select cartridge 314, the first lead 331 extends from a first end of the first coil 801 and the eleventh lead 341 extends from a second end of the fifth coil 805, at which point the first lead 331 and the eleventh lead 341 connect to the first output lead 351 which connects to the first input 901 of the circuit breaker. The second lead 332 extends from a first end of the second coil 802 and the twelfth lead 342 extends from a second end of the sixth coil 806 at which point the second lead 332 and the twelfth lead 342 connect to the second output lead 352 which connects to the second input 902 of the circuit breaker. The third lead 333 extends from a first end of the third coil 803 and the tenth lead 340 extends from a second end of the fourth coil 804 at which point the third lead 333 and the tenth lead 340 connect to the third output lead 353 which connects to the third input 903 of the circuit breaker. The fourth lead 334 extends from a second end of the first coil 801 and the seventh lead 337 extends from a first end of the fourth coil 804 at which point the fourth lead 334 and the seventh lead 337 connect to the neutral output lead 354 which connects to the neutral input 904. The fifth lead 335 extends from a second end of the second coil 802 at which point it connects to the eighth lead 338, which extends from a first end of the fifth coil 805. The sixth lead 336 extends from a second end of the third coil 803, at which point it connects to the ninth lead 339, which extends from a first end of the sixth coil 806.

In some examples, when measured between the first output lead 351 and the second output lead 352 when the connector assembly 112 is in the configuration of FIG. 19, the alternator 106 produces a voltage differential of 240V. In some examples, when measured between the first output lead 351 and the neutral output lead 354 when the connector assembly 112 is in the configuration of FIG. 19, the alternator 106 produces a voltage differential of 120V.

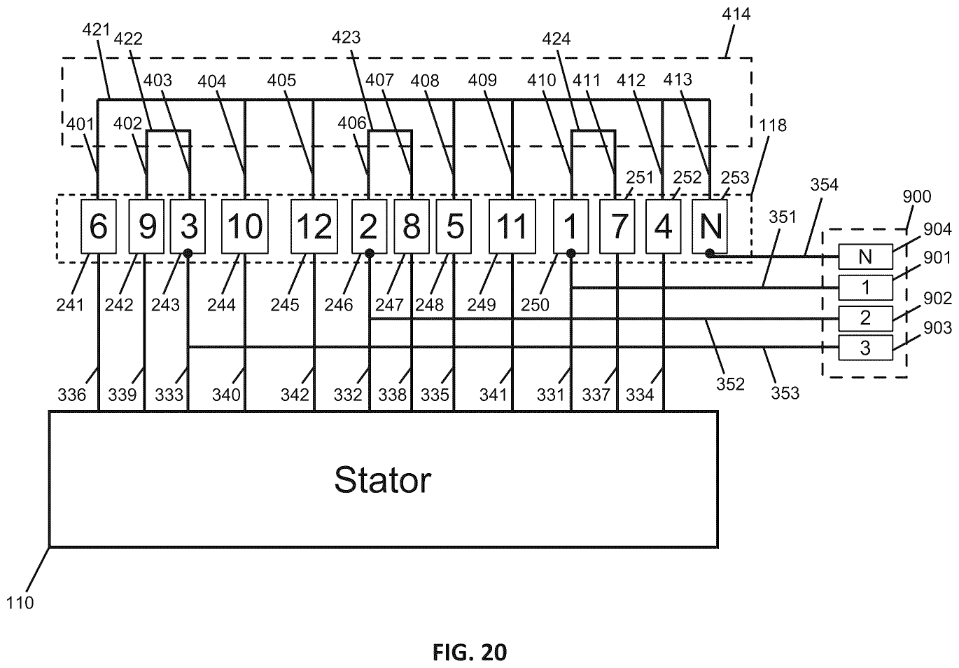

FIG. 20 is a schematic view of FIG. 17 with the voltage select cartridge 414 arranged therein. In some examples, when the voltage select cartridge 414 is arranged within the connector assembly 112 the arrangement of the tabs 401, 402, 403, 404, 405, 406, 407, 408, 409, 410, 411, 412, 413 within the terminals 241, 242, 243, 244, 245, 246, 247, 248, 249, 250, 251, 252, 253 is substantially similar to the arrangement of the tabs 301, 302, 303, 304, 305, 306, 307, 308, 309, 310, 311, 312, 313 within the terminals within the terminals 241, 242, 243, 244, 245, 246, 247, 248, 249, 250, 251, 252, 253 as described above with reference to FIG. 17. In some examples, when arranged in the configuration of FIG. 20, the connector assembly 112 is configured to output a phase to neutral voltage of 120V and a phase to phase voltage of 208V to the circuit breaker 900.

In some examples, as depicted in FIG. 20, when the stator leads 331, 332, 333, 334, 335, 336, 337, 338, 339, 340, 341, 342, are connected to the terminals 241, 242, 243, 244, 245, 246, 247, 248, 249, 250, 251, 252; the tabs 401, 402, 403, 404, 405, 406, 407, 408, 409, 410, 411, 412, 413 are connected to the terminals 241, 242, 243, 244, 245, 246, 247, 248, 249, 250, 251, 252, 253; and the circuit breaker inputs 901, 902, 903, 904 are connected to the terminals 243, 246, 250, 253, one or more of the above referenced components form an electrical connection.

Specifically, the sixth lead 336, the first tab 401, the first trace 421, the fourth tab 404, the tenth lead 340, the fifth tab 405, the twelfth lead 342, the eighth tab 408, the fifth lead 335, the ninth tab 409, the eleventh lead 341, the twelfth tab 412, the fourth lead 334, the thirteenth tab 413, the neutral output lead 354, and the neutral input 904 are electrically connected. The ninth lead 339, the second tab 402, the second trace 422, the third tab 403, the third lead 333, the third output lead 353, and the third input 903 are electrically connected. The second lead 332, the second output lead 352, the second input 902, the sixth tab 406, the third trace 423, the seventh tab 407, and the eighth lead 338 are electrically connected. The first lead 331, the first output lead 351, the first input 901, the tenth tab 410, the fourth trace 424, the eleventh tab 411, and the seventh lead 337 are electrically connected.

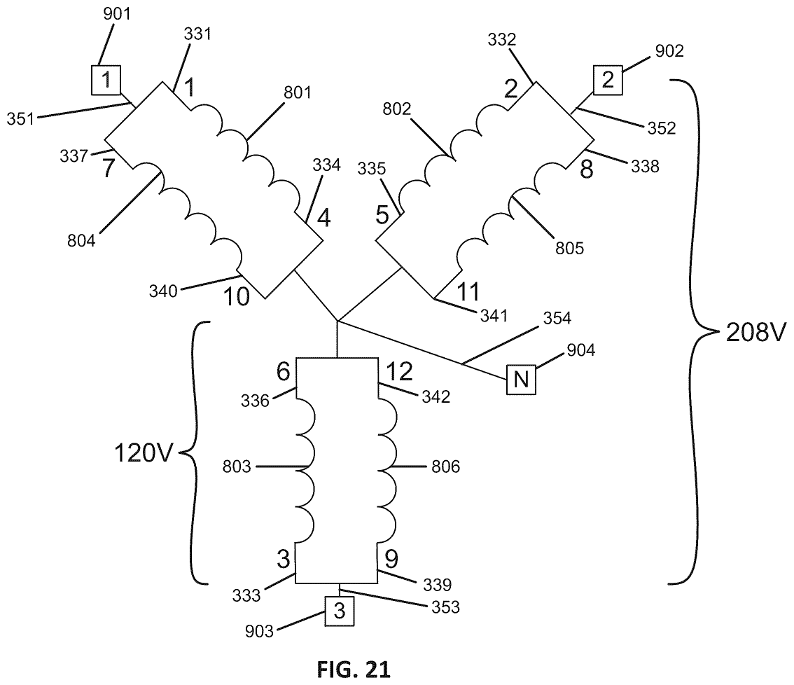

FIG. 21 is a circuit diagram of the stator leads and coils when connected to the connector assembly 112 and voltage select cartridge 414, depicted in FIG. 20. In the example of FIG. 21, the first coil 801, second coil 802, third coil 803, fourth coil 804, fifth coil 805, and sixth coil 806 of the stator 110 are shown. As shown in FIG. 20, when connected to the connector assembly 112 and voltage select cartridge 414, the first lead 331 extends from a first end of the first coil 801 and the seventh lead 337 extends from a first end of the fourth coil 804, at which point the first lead 331 and the seventh lead 337 connect to the first output lead 351 which connects to the first input 901 of the circuit breaker. The second lead 332 extends from a first end of the second coil 802 and the eighth lead 338 extends from a first end of the fifth coil 805 at which point the second lead 332 and the eighth lead 338 connect to the second output lead 352 which connects to the second input 902 of the circuit breaker. The third lead 333 extends from a first end of the third coil 803 and the ninth lead 339 extends from a first end of the sixth coil 806 at which point the third lead 333 and the ninth lead 339 connect to the third output lead 353 which connects to the third input 903 of the circuit breaker. The fourth lead 334 extends from a second end of the first coil 801 and the tenth lead 340 extends from a second end of the fourth coil 804 at which point the fourth lead 334 and the tenth lead 340 connect to the neutral output lead 354 which connects to the neutral input 904. The fifth lead 335 extends from a second end of the second coil 802 and the eleventh lead 341 extends from a second end of the fifth coil 805 at which point the fifth lead 335 and the eleventh lead 341 connect to the neutral output lead 354 which connects to the neutral input 904. The sixth lead 336 extends from a second end of the third coil 803 and the twelfth lead 342 extends from a second end of the sixth coil 806 at which point the sixth lead 336 and the twelfth lead 342 connect to the neutral output lead 354 which connects to the neutral input 904.

In some examples, when measured between the third output lead 353 and the neutral output lead 354 when the connector assembly 112 is in the configuration of FIG. 21, the alternator 106 produces a voltage differential of 120V. In some examples, when measured between the third output lead 353 and the second output lead 352 when the connector assembly 112 is in the configuration of FIG. 21, the alternator 106 produces a voltage differential of 208V.

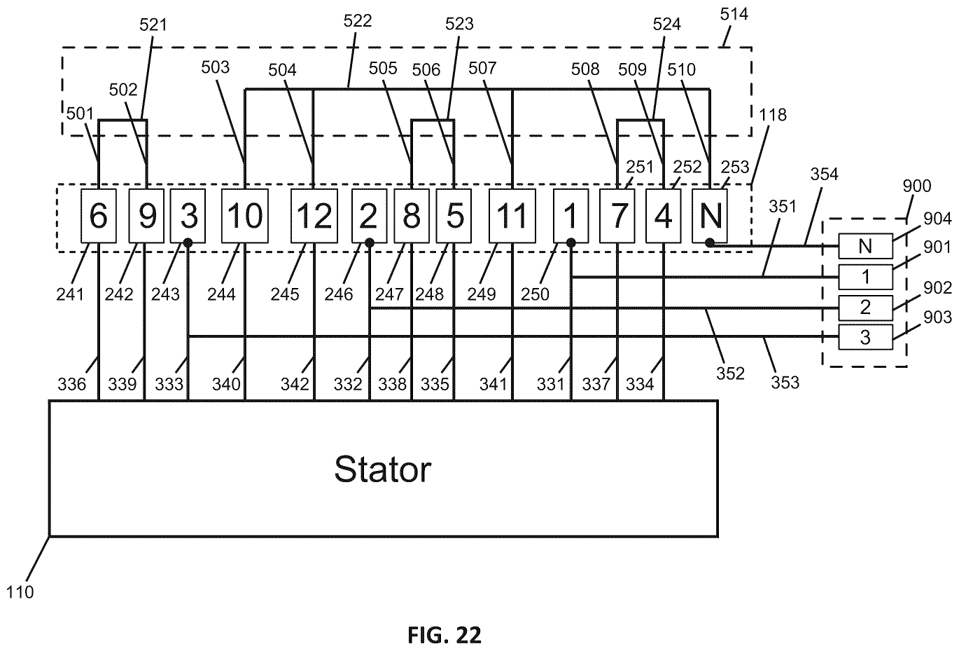

FIG. 22 is a schematic diagram of the connector assembly 112 with the voltage select cartridge 514 arranged therein. In some examples, when the voltage select cartridge 514 is arranged within the connector assembly 112 first tab 501 is arranged within the first terminal 241, the second tab 502 is arranged within the second terminal 242, the third tab 503 is arranged within the fourth terminal 244, the fourth tab 504 is arranged within the fifth terminal 245, the fifth tab 505 is arranged within the seventh terminal 247, the sixth tab 506 is arranged within the eighth terminal 248, the seventh tab 507 is arranged within the ninth terminal 249, eighth tab 508 is arranged within the eleventh terminal 251, the ninth tab 509 is arranged within the twelfth terminal, and the tenth tab 510 is arranged within the thirteenth terminal 253. In some examples, when arranged in the configuration of FIG. 22, the connector assembly 112 is configured to output a voltage of 277/480V to the circuit breaker 900.

In some examples, as depicted in FIG. 22, when the stator leads 331, 332, 333, 334, 335, 336, 337, 338, 339, 340, 341, 342, are connected to the terminals 241, 242, 243, 244, 245, 246, 247, 248, 249, 250, 251, 252, the tabs 501, 502, 503, 504, 505, 506, 507, 508, 509, 510 are connected to the terminals 241, 242, 244, 245, 247, 248, 249, 251, 252, 253; and the circuit breaker inputs 901, 902, 903, 904 are connected to the terminals 243, 246, 250, 253, one or more of the above referenced components form an electrical connection.

Specifically, the sixth lead 336, the first tab 501, the first trace 521, the second tab 502, and the ninth lead 339 are electrically connected. The third lead 333, the third output lead 353, and the third input 903 are electrically connected. The tenth lead 340, the third tab 503, the second trace 522, the fourth tab 504, the twelfth lead 342, the seventh tab 507, the eleventh lead 341, the tenth tab 510, the neutral output lead 354, and the neutral input 904 are electrically connected. The second lead 332, the second output lead 352, and the second input 902 are electrically connected. The eighth lead 338, the fifth tab 505, the third trace 523, the sixth tab 506, and the fifth lead 335 are electrically connected. The first lead 331, the first output lead 351, the first input 901 are electrically connected. The seventh lead 337, the eighth tab 508, the fourth trace 524, the ninth tab 509, and the fourth lead 334 are electrically connected.

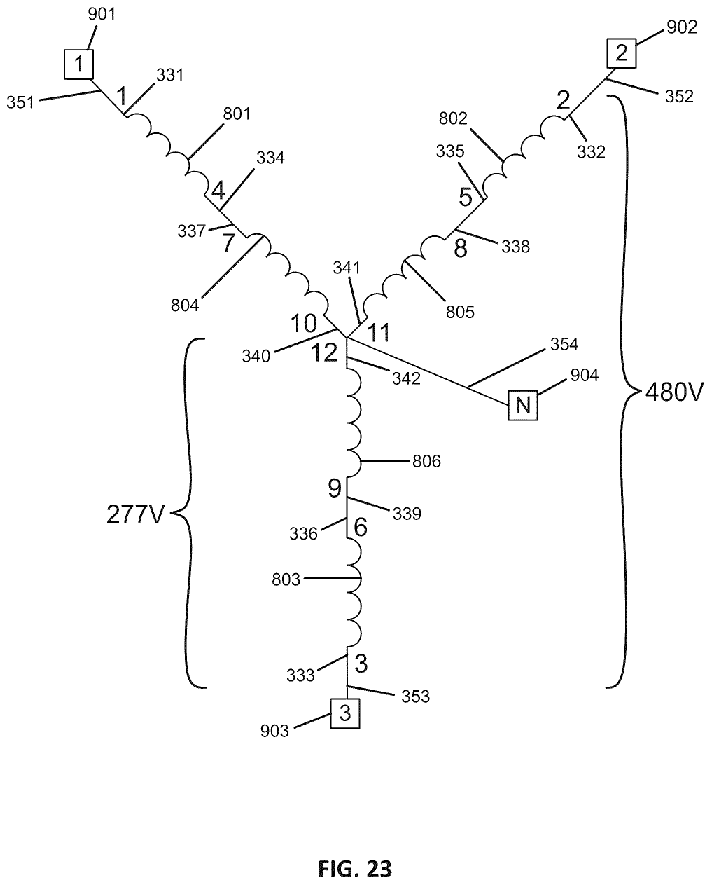

FIG. 23 is a circuit diagram of the stator leads and coils when connected to the connector assembly 112 and voltage select cartridge 514, depicted in FIG. 22. In the example of FIG. 23, the first coil 801, second coil 802, third coil 803, fourth coil 804, fifth coil 805, and sixth coil 806 of the stator 110 are shown. As shown in FIG. 23, when connected to the connector assembly 112 and voltage select cartridge 514, the first lead 331 extends from the first end of the first coil 801 and connects to the first output lead 351, which connects to the first input 901 of the circuit breaker. The fourth lead 334 extends from the second end of the first coil 801 and connects to the seventh lead 337, which extends from a first end of the fourth coil 804. The second lead 332 extends from a first end of the second coil 802 and connects to the second output lead 352, which connects to the second input 902 of the circuit breaker. The fifth lead 335 extends from a second end of the second coil 802 and connects to the eighth lead 338, which extends from a first end of the fifth coil 805. The third lead 333 extends from the first end of the third coil and connects to the third output lead 353, which connects to the third input 903 of the circuit breaker. The sixth lead 336 extends from a second end of the third coil 803 and connects to the ninth lead 339, which extends from a first end of the sixth coil 806. The tenth lead 340, eleventh lead 341, and twelfth lead 342 each extend from the second ends of the fourth coil 804, fifth coil 805, and sixth coil 806, respectively and connect to the neutral output lead 354, which connects to the neutral input 904 of the circuit breaker.

In some examples, when measured between the third output lead 353 and the neutral output lead 354 when the connector assembly 112 is in the configuration of FIG. 23, the alternator 106 produces a voltage differential of 277V. In some examples, when measured between the third output lead 353 and the second output lead 352 when the connector assembly 112 is in the configuration of FIG. 23, the alternator 106 produces a voltage differential of 480V.

In some examples, regardless of the voltage select cartridge 114, 314, 414, 514 used with the connector assembly 112, the connection configuration between the stator 110, the terminal block assembly 118, and the circuit breaker 900 remains the same. In such examples, the change in connection configuration results from the change in the voltage select cartridge 114, 314, 414, 514 used with the connector assembly 112 to provide different output voltages for the connector assembly 112. In such examples, the leads of the stator 110 and the leads of the circuit breaker 900 need not be rewired when a different output from the alternator 106 is desired. Rather, an operator need only remove one of the voltage select cartridges 114, 314, 414, 514 from the connector assembly 112 and insert another of the voltage select cartridges 114, 314, 414, 514 with in the connector assembly 112 in order to provide a different voltage output from the alternator 106.

While the above description provides specific examples of the connector assembly used in conjunction with a twelve lead three-phase alternator, in other embodiments, the connector assembly 112 is used with different types of three-phase alternators, such as, for example, a six lead alternator. In some examples, the connector assembly 112 may be provided with specific voltage select cartridges that allow for the voltage of such a six lead alternator to be varied. In such embodiments, the six leads are connected to the terminals of the connector assembly and the voltage select cartridge is configured to connect one or more of the six leads to each other. In some such embodiments, the terminal block assembly includes seven terminals.

In some examples, the connector assembly 112 is used with a voltage select cartridge that is configured to allow for the generator to produce a single phase output.

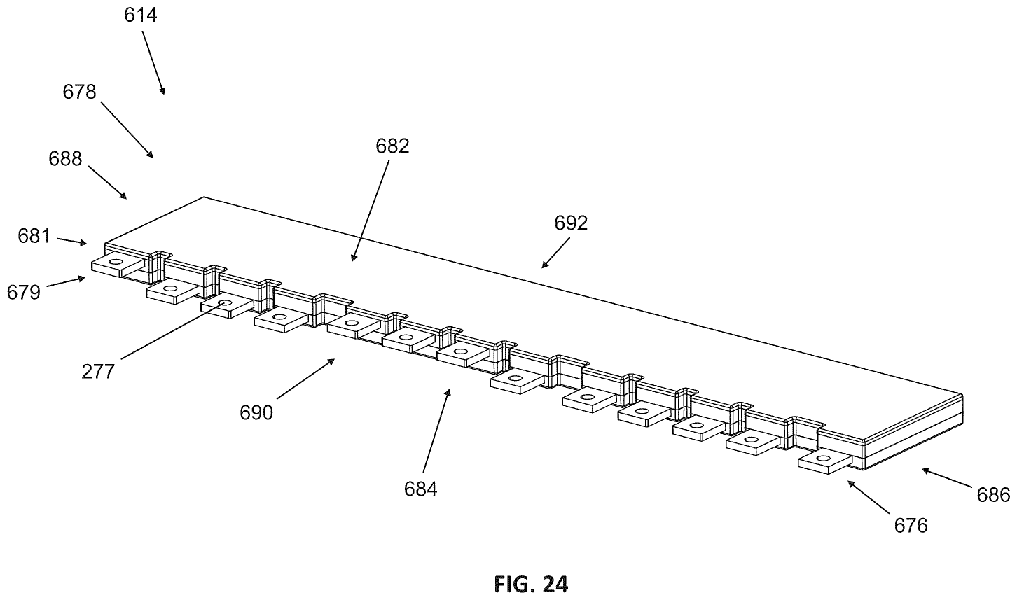

FIG. 24 is a perspective view of another example voltage select cartridge 614 that can be substituted for any one of the voltage select cartridges 114, 314, 414, 514 and used in the connector assembly of FIG. 3. The voltage select cartridge 614 includes a top side 682, a bottom side 684, a left side 686, a right side 688, a front side 690, and a rear side 692. In some examples, the voltage select cartridge 614 further includes a plurality of tabs 676 and a bus bar system 678. In some examples, the voltage select cartridge 614 is generally planar in shape. In some examples, the voltage select cartridge 614 is configured similarly in many aspects to the voltage select cartridge 114 of FIG. 10 or the voltage select cartridge 214 of FIG. 11.

In some examples, the voltage select cartridge 614 differs from the voltage select cartridge 114 of FIG. 10 in that the voltage select cartridge 614 comprises a first layer 679 and a second layer 681. In some examples, the first layer 679 of the voltage select cartridge 614 comprises nine tabs 676 and the second layer 681 comprises four tabs 676. In some examples, the voltage select cartridge 614 comprises a fourth trace configuration.

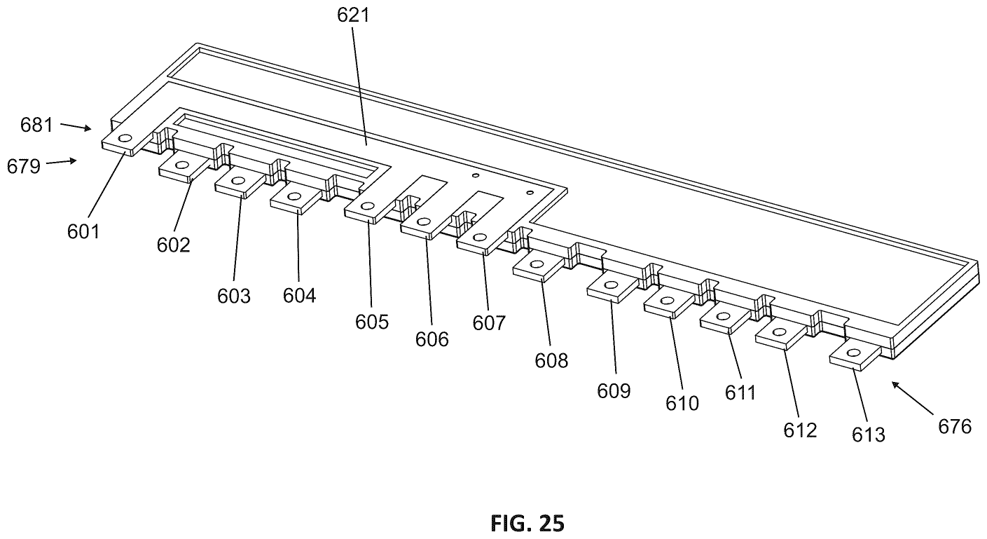

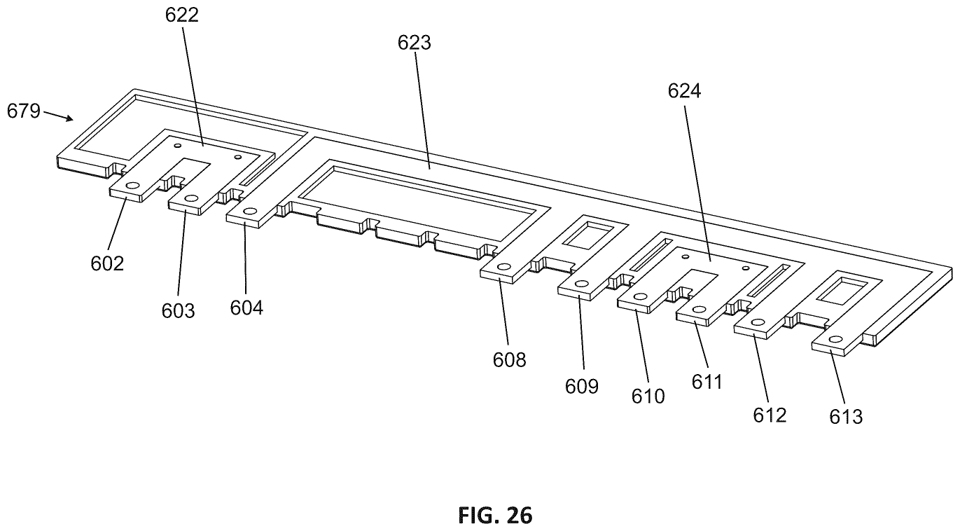

FIG. 25 and FIG. 26 are cross sectional views of the voltage select cartridge of FIG. 24, depicting the fourth trace configuration. FIG. 25 depicts a second layer 681 of the fourth trace configuration. FIG. 26 depicts a first layer 679 of the fourth trace configuration. In some examples, the fourth trace configuration is configured to provide a phase to neutral output voltage of 120V and a phase to phase output voltage of 240V. In some examples, the fourth trace configuration is configured to provide a single phase output. In the example of FIG. 25, the voltage select cartridge 614 includes a first tab 601, a second tab 602, a third tab 603, a fourth tab 604, a fifth tab 605, a sixth tab 606, a seventh tab 607, an eighth tab 608, a ninth tab 609, a tenth tab 610, an eleventh tab 611, a twelfth tab 612, a thirteenth tab 613, a first trace 621, a second trace 622, a third trace 623, and a fourth trace 624.

In some examples, the second layer 681 comprises the first tab 601, the fifth tab 605, the sixth tab 606, and the seventh tab 607. In some examples, the second layer 681 further comprises the first trace 621.

In some examples, the first layer 679 comprises the second tab 602, the third tab 603, the fourth tab 604, the eighth tab 608, the ninth tab 609, the tenth tab 610, the eleventh tab 611, the twelfth tab 612, and the thirteenth tab 613. In some examples, the first layer 679 further comprises the second trace 622, the third trace 623, and the fourth trace 624.

In the example of FIG. 25 and FIG. 26, each of the first tab 601, the fifth tab 605, the sixth tab 606, and the seventh tab 607 are conductively connected by the first trace 621. The second tab 602 is conductively connected by the second trace 622 to the third tab 603. The fourth tab 604, the eighth tab 608, the ninth tab 609, the twelfth tab 612, and the thirteenth tab 613 are conductively connected by the third trace 623. The tenth tab 610 and the eleventh tab 611 are conductively connected by the fourth trace 624. In some examples, the second layer 681 is arranged on top of the first layer 679. In some examples, the second layer 681 and the first layer 679 are separated from each other by a dielectric material. In some examples, the tabs 676 of the voltage select cartridge 614 are configured to interact with the base 121 of the connector assembly 112 in a manner that is similar in many aspects to that which is described with respect to the voltage select cartridge 114 in FIGS. 12, 13, and 17.

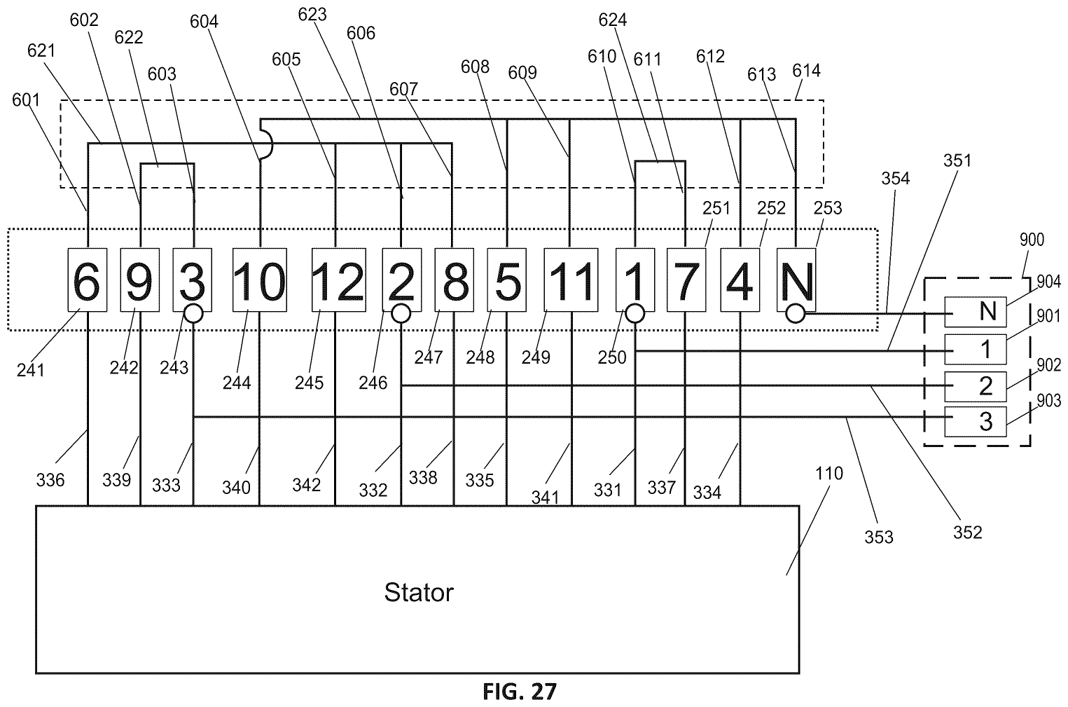

FIG. 27 is a schematic view of the connector assembly of FIG. 3 with the voltage select cartridge 614 of FIG. 24 arranged therein. In some examples, when the voltage select cartridge 614 is arranged within the connector assembly 112 the arrangement of the tabs 601, 602, 603, 604, 605, 606, 607, 608, 609, 610, 611, 612, 613 within the terminals 241, 242, 243, 244, 245, 246, 247, 248, 249, 250, 251, 252, 253 is substantially similar to the arrangement of the tabs 301, 302, 303, 304, 305, 306, 307, 308, 309, 310, 311, 312, 313 within the terminals within the terminals 241, 242, 243, 244, 245, 246, 247, 248, 249, 250, 251, 252, 253 as described above with reference to FIG. 17. In some examples, when arranged in the configuration of FIG. 27, the connector assembly 112 is configured to output a phase to neutral voltage of 120V and a phase to phase voltage of 240V to the circuit breaker 900. In some examples, when arranged in the configuration of FIG. 27, the connector assembly 112 is configured to provide a single phase output.

In some examples, as depicted in FIG. 27, when the stator leads 331, 332, 333, 334, 335, 336, 337, 338, 339, 340, 341, 342, are connected to the terminals 241, 242, 243, 244, 245, 246, 247, 248, 249, 250, 251, 252, the tabs 601, 602, 603, 604, 605, 606, 607, 608, 609, 610, 611, 612, 613 are connected to the terminals 241, 242, 243, 244, 245, 246, 247, 248, 249, 250, 251, 252, 253; and the circuit breaker inputs 901, 902, 903, 904 are connected to the terminals 243, 246, 250, 253, one or more of the above referenced components form an electrical connection.

Specifically, the first trace 621, the first tab 601, the fifth tab 605, the sixth tab 606, the seventh tab 607, sixth lead 336, the twelfth lead 342, the second lead 332, the eighth lead 338, and the second output lead 352, and the second input 902 are electrically connected. The second trace 622, the second tab 602, the third tab 603, the ninth lead 339, the third lead 333 the third output lead 353, and the third input are electrically connected. The third trace 623, the fourth tab 604, the eighth tab 608, the ninth tab 609, the twelfth tab 612, the thirteenth tab 613, the tenth lead 340, the fifth lead 335, the eleventh lead 341, the fourth lead 334, the neutral output lead 354, and the neutral input 904 are electrically connected. The fourth trace 624, tenth tab 610, the eleventh tab 611, the first lead 331, the seventh lead 337, the first output lead 351, and the first input 901 are electrically connected.

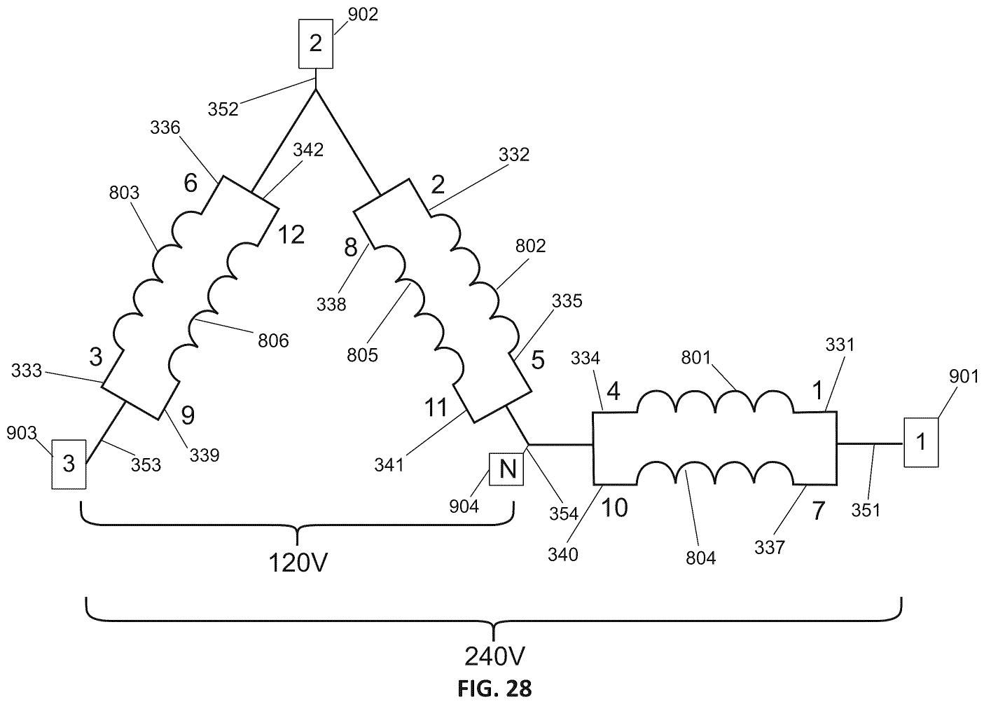

FIG. 28 is a circuit diagram of the stator leads and coils when connected to the connector assembly 112 and voltage select cartridge 614, depicted in FIG. 27. In the example of FIG. 28, the first coil 801, second coil 802, third coil 803, fourth coil 804, fifth coil 805, and sixth coil 806 of the stator 110 are shown. As shown in FIG. 28, when connected to the connector assembly 112 and voltage select cartridge 614, the first lead 331 extends from a first end of the first coil 801 and the seventh lead 337 extends from a first end of the fourth coil 804, at which point the first lead 331 and the seventh lead 337 connect to the first output lead 351 which connects to the first input 901 of the circuit breaker. The second lead 332 extends from a first end of the second coil 802 and the eighth lead 338 extends from a first end of the fifth coil 805 at which point the second lead 332 and the eighth lead 338 connect to the second output lead 352 which connects to the second input 902 of the circuit breaker. The third lead 333 extends from a first end of the third coil 803 and the ninth lead 339 extends from a first end of the sixth coil 806 at which point the third lead 333 and the ninth lead 339 connect to the third output lead 353 which connects to the third input 903 of the circuit breaker. The fourth lead 334 extends from a second end of the first coil 801 and the tenth lead 340 extends from a second end of the fourth coil 804 at which point the fourth lead 334 and the tenth lead 340 connect to the neutral output lead 354 which connects to the neutral input 904. The fifth lead 335 extends from a second end of the second coil 802 and the eleventh lead 341 extends from a second end of the fifth coil 805 at which point the fifth lead 335 and the eleventh lead 341 connect to the neutral output lead 354 which connects to the neutral input 904. The sixth lead 336 extends from a second end of the third coil 803 and the twelfth lead 342 extends from a second end of the sixth coil 806 at which point the sixth lead 336 and the twelfth lead 342 connect to the second output lead 352 which connects to the second input 902.

In some examples, when measured between the third output lead 353 and the neutral output lead 354 when the connector assembly 112 is in the configuration of FIG. 28, the alternator 106 produces a voltage differential of 120V. In some examples, when measured between the third output lead 353 and the first output lead 351 when the connector assembly 112 is in the configuration of FIG. 28, the alternator 106 produces a voltage differential of 240V.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. An alternator for a three-phase generator, the alternator comprising:
a rotor;
a stator having a plurality of coils arranged thereon, each coil of the plurality of coils including two associated leads;
a terminal block assembly to which each one of the two associated leads of each one of the plurality of coils are attached, the terminal block assembly including a plurality of terminals, each one of the two associated leads of each one of the plurality of coils being connected to a terminal; and
a cartridge that is selectively connected to the terminal block assembly, the cartridge being electrically coupled to a plurality of the leads when the cartridge is connected to the terminal block assembly, the cartridge including a conductive portion that extends between and electrically couples a first lead to a second lead of the plurality of the leads.

2. The alternator of claim 1, wherein the alternator is configured to produce a three-phase output.

3. The alternator of claim 1, wherein the alternator is configured to produce a single phase output.

4. The alternator of claim 1, wherein each port of the plurality of terminals includes a lead connection post and a cartridge connection post, the lead connection post being electrically coupled to the cartridge connection post by a connection bar.

5. The alternator of claim 4, wherein the each one of the two associated leads of each one of the plurality of coils are electrically coupled to each one of the lead connection posts of each one of the plurality of terminals.

6. The alternator of claim 5, wherein the cartridge includes a plurality of tabs, wherein each one of the plurality of tabs includes a hole arranged therethrough, wherein each one of the holes of each one of the plurality of tabs receives one of the cartridge connection posts when the cartridge is selectively connected to the terminal block assembly.

7. The alternator of claim 1, wherein the cartridge is a first cartridge, and wherein the alternator further comprises a second cartridge, wherein either one of the first cartridge or the second cartridge is selectively coupled to the terminal block assembly.

8. The alternator of claim 7, wherein the terminal block assembly produces a first output voltage when the first cartridge is connected thereto, and wherein the terminal block assembly produces a second output voltage when the second cartridge is connected thereto.

9. The alternator of claim 8, further comprising a third cartridge, wherein either one of the first cartridge, the second cartridge, or the third cartridge is selectively coupled to the terminal block assembly, and wherein the terminal block assembly produces a third output voltage when the third cartridge is connected thereto.

10. The alternator of claim 1, further comprising a plurality of output leads, the plurality of output leads being configured to provide an output voltage from the terminal block assembly.

11. A connection assembly for reconfiguring the voltage output from an alternator, the connection assembly comprising:
a terminal block assembly comprising a plurality of terminals; and
a first cartridge that is selectively connected to the terminal block assembly;
the terminal block assembly being configured to receive a plurality of leads from the alternator within the plurality of terminals; and
the terminal block assembly further being configured to receive the first cartridge, the first cartridge providing an electrical connection between a first lead of the plurality of leads and a second lead of the plurality of leads when the first cartridge is received within the terminal block assembly.

12. The connection assembly of claim 11 further comprising:
a second cartridge that is selectively connected to the terminal block assembly, the second cartridge providing an electrical connection between a third lead of the plurality of leads and a fourth lead of the plurality of leads.

13. The connection assembly of claim 12, wherein only one of the first cartridge and the second cartridge is connected to the terminal block assembly at a time.

14. The connection assembly of claim 12, wherein the first cartridge is configured to cause the terminal block assembly to produce a first output phase-to-phase voltage and a first output phase-to-neutral voltage and wherein the second cartridge is configured to cause the terminal block assembly to produce a second output phase-to-phase voltage and a second output phase-to-neutral voltage.

15. The connection assembly of claim 14, wherein the first output phase-to-phase voltage is a three-phase 240V voltage and the first output phase to neutral voltage is a three-phase 120V voltage.

16. The connection assembly of claim 14, wherein the first output phase-to-phase voltage is a three-phase 208V voltage and the first output phase-to-neutral voltage is a three-phase 120V voltage.

17. The connection assembly of claim 14, wherein the first output phase-to-phase voltage is three-phase 480V voltage and the first output phase-to-neutral voltage is three-phase 277V voltage.

18. The connection assembly of claim 14, wherein the first output phase-to-phase voltage is a single-phase 240V voltage and the first output phase-to-neutral voltage is a single-phase 120V voltage.

19. The connection assembly of claim 11, wherein each terminal of the plurality of terminals includes a lead connection post and a cartridge connection post.

20. The connection assembly of claim 19, wherein the cartridge connection posts are configured to extend through holes in conductive tabs of the first cartridge.
